(19) United States
(12) Patent Application Publication
(10) Pub. No.: US 2023/0319591 A1
(43) Pub. Date: Oct. 5, 2023

(54) TRANSMISSION CONFIGURATION INDICATORS (TCIS) FOR JOINT DOWNLINK/UPLINK BEAMS

(71) Applicant: QUALCOMM Incorporated, San Diego, CA (US)

(72) Inventors: Yan ZHOU, San Diego, CA (US); Fang YUAN, Beijing (CN); Tao LUO, San Diego, CA (US)

(21) Appl. No.: 18/006,357

(22) PCT Filed: Sep. 9, 2020
(86) PCT No.: PCT/CN2020/114203

§ 371 Date: Jan. 20, 2023

(51) Int. Cl. H04W 16/28; H04W 56/00; H04W 72/20

(52) U.S. Cl. CPC H04W 16/28; H04W 56/0045; H04W 72/20

(57) ABSTRACT

This disclosure provides systems, methods and apparatuses for transmitting and receiving a transmission configuration indicator (TCI) for a joint downlink/uplink beam. A base station (BS) may transmit the TCI that indicates one or more reference signals providing a user equipment (UE) with properties for the beam used by the UE to transmit data or control information on an uplink as well as used by the UE to receive data or control information on a downlink. Accordingly, the UE and the BS may reduce signaling and network overhead by using a single TCI to indicate quasi-co-location (QCL) rules for both uplink and downlink.

### TECHNICAL FIELD

Aspects of the present disclosure relate generally to wireless communication and to techniques for transmitting and receiving transmission configuration indicators (TCIs) for joint downlink/uplink beams.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink (DL) and uplink (UL). The DL (or forward link) refers to the communication link from the BS to the UE, and the UL (or reverse link) refers to the communication link from the UE to the BS. As will be described in more detail herein, a BS may be referred to as a NodeB, an LTE evolved nodeB (eNB), a gNB, an access point (AP), a radio head, a transmit receive point (TRP), a New Radio (NR) BS, or a 5G NodeB.

The above multiple access technologies have been adopted in various telecommunication standards to provide a common protocol that enables different UEs to communicate on a municipal, national, regional, and even global level. NR, which also may be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency-division multiplexing (OFDM) with a cyclic prefix (CP) (CP-OFDM) on the DL, using CP-OFDM or SC-FDM (for example, also known as discrete Fourier transform spread OFDM (DFT-s-OFDM)) on the UL (or a combination thereof), as well as supporting beamforming, multiple-input multiple-output (MIMO) antenna technology, and carrier aggregation.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method of wireless communication performed by an apparatus of a user equipment (UE). The method may include receiving, from a base station (BS), a transmission configuration indicator (TCI) for a beam, where the TCI indicates one or more reference signals providing one or more properties of the beam; transmitting, to the BS, uplink data or control information using the beam; and receiving, from the BS, downlink data or control information using the beam.

Another innovative aspect of the subject matter described in this disclosure can be implemented in an apparatus of a UE for wireless communication. The apparatus may include a first interface configured to obtain a TCI for a beam, where the TCI indicates one or more reference signals providing one or more properties of the beam. The apparatus may include a second interface configured to output uplink data or control information using the beam. The first interface may be further configured to obtain downlink data or control information using the beam.

Another innovative aspect of the subject matter described in this disclosure can be implemented in a non-transitory computer-readable medium. The non-transitory computer-readable medium may store one or more instructions for wireless communication. The one or more instructions, when executed by one or more processors of a UE, may cause the one or more processors to receive, from a BS, a TCI for a beam, where the TCI indicates one or more reference signals providing one or more properties of the beam; transmit, to the BS, uplink data or control information using the beam; and receive, from the BS, downlink data or control information using the beam.

Another innovative aspect of the subject matter described in this disclosure can be implemented in an apparatus for wireless communication. The apparatus may include means for receiving, from a BS, a TCI for a beam, where the TCI indicates one or more reference signals providing one or more properties of the beam; means for transmitting, to the BS, uplink data or control information using the beam; and means for receiving, from the BS, downlink data or control information using the beam.

One innovative aspect of the subject matter described in this disclosure can be implemented in a method of wireless communication performed by an apparatus of a BS. The method may include transmitting, to a UE, a TCI for a beam, where the TCI indicates one or more reference signals providing one or more properties of the beam; receiving, from the UE, uplink data or control information using the beam; and transmitting, to the UE, downlink data or control information using the beam.

Another innovative aspect of the subject matter described in this disclosure can be implemented in an apparatus of a BS for wireless communication. The apparatus may include a first interface configured to output a TCI for a beam, where the TCI indicates one or more reference signals providing one or more properties of the beam. The apparatus may include a second interface configured to obtain uplink data or control information using the beam. The first interface may be further configured to output downlink data or control information using the beam.

Another innovative aspect of the subject matter described in this disclosure can be implemented in a non-transitory computer-readable medium. The non-transitory computer-readable medium may store one or more instructions for wireless communication. The one or more instructions, when executed by one or more processors of a BS, may cause the one or more processors to transmit, to a UE, a TCI for a beam, where the TCI indicates one or more reference signals providing one or more properties of the beam; receive, from the UE, uplink data or control information using the beam; and transmit, to the UE, downlink data or control information using the beam.

Another innovative aspect of the subject matter described in this disclosure can be implemented in an apparatus for wireless communication. The apparatus may include means for transmitting, to a UE, a TCI for a beam, where the TCI indicates one or more reference signals providing one or more properties of the beam; means for receiving, from the UE, uplink data or control information using the beam; and means for transmitting, to the UE, downlink data or control information using the beam.

One innovative aspect of the subject matter described in this disclosure can be implemented in a method of wireless communication performed by an apparatus of a UE. The method may include receiving a communication from a non-serving neighbor cell and determining a parameter associated with a joint downlink and uplink TCI state based on the received communication from the non-serving neighbor cell.

Another innovative aspect of the subject matter described in this disclosure can be implemented in an apparatus of a UE for wireless communication. The apparatus may include an interface configured to obtain a communication from a non-serving neighbor cell. The apparatus may include a processing system configured to determine a parameter associated with a joint downlink and uplink TCI state based on the received communication from the non-serving neighbor cell.

Another innovative aspect of the subject matter described in this disclosure can be implemented in a non-transitory computer-readable medium. The non-transitory computer-readable medium may store one or more instructions for wireless communication. The one or more instructions, when executed by one or more processors of a UE, may cause the one or more processors to receive a communication from a non-serving neighbor cell and determine a parameter associated with a joint downlink and uplink TCI state based on the received communication from the non-serving neighbor cell.

Another innovative aspect of the subject matter described in this disclosure can be implemented in an apparatus for wireless communication. The apparatus may include means for receiving a communication from a non-serving neighbor cell and means for determining a parameter associated with a joint downlink and uplink TCI state based on the received communication from the non-serving neighbor cell.

One innovative aspect of the subject matter described in this disclosure can be implemented in a method of wireless communication performed by an apparatus of a UE. The method may include receiving a communication from a non-serving neighbor cell and determining an uplink spatial relationship parameter associated with an uplink TCI state based on the received communication from the non-serving neighbor cell.

Another innovative aspect of the subject matter described in this disclosure can be implemented in an apparatus of a UE for wireless communication. The apparatus may include an interface configured to obtain a communication from a non-serving neighbor cell. The apparatus may include a processing system configured to determine an uplink spatial relationship parameter associated with an uplink TCI state based on the received communication from the non-serving neighbor cell.

Another innovative aspect of the subject matter described in this disclosure can be implemented in a non-transitory computer-readable medium. The non-transitory computer-readable medium may store one or more instructions for wireless communication. The one or more instructions, when executed by one or more processors of a UE, may cause the one or more processors to receive a communication from a non-serving neighbor cell and determine an uplink spatial relationship parameter associated with an uplink TCI state based on the received communication from the non-serving neighbor cell.

Another innovative aspect of the subject matter described in this disclosure can be implemented in an apparatus for wireless communication. The apparatus may include means for receiving a communication from a non-serving neighbor cell and means for determining an uplink spatial relationship parameter associated with an uplink TCI state based on the received communication from the non-serving neighbor cell.

One innovative aspect of the subject matter described in this disclosure can be implemented in a method of wireless communication performed by an apparatus of a BS. The method may include determining a parameter associated with a joint downlink and uplink TCI state and transmitting a communication via a non-serving neighbor cell to indicate the parameter.

Another innovative aspect of the subject matter described in this disclosure can be implemented in an apparatus of a BS for wireless communication. The apparatus may include a processing system configured to determine a parameter associated with a joint downlink and uplink TCI state. The apparatus may include an interface configured to output a communication for transmission via a non-serving neighbor cell to indicate the parameter.

Another innovative aspect of the subject matter described in this disclosure can be implemented in a non-transitory computer-readable medium. The non-transitory computer-readable medium may store one or more instructions for wireless communication. The one or more instructions, when executed by one or more processors of a BS, may cause the one or more processors to determine a parameter associated with a joint downlink and uplink TCI state and transmit a communication via a non-serving neighbor cell to indicate the parameter.

Another innovative aspect of the subject matter described in this disclosure can be implemented in an apparatus for wireless communication. The apparatus may include means for determining a parameter associated with a joint downlink and uplink TCI state and means for transmitting a communication via a non-serving neighbor cell to indicate the parameter.

One innovative aspect of the subject matter described in this disclosure can be implemented in a method of wireless communication performed by an apparatus of a BS. The method may include determining an uplink spatial relationship parameter associated with an uplink TCI state and transmitting a communication via a non-serving neighbor cell to indicate the parameter.

Another innovative aspect of the subject matter described in this disclosure can be implemented in an apparatus of a BS for wireless communication. The apparatus may include a processing system configured to determine an uplink spatial relationship parameter associated with an uplink TCI state. The apparatus may include an interface configured to output a communication for transmission via a non-serving neighbor cell to indicate the parameter.

Another innovative aspect of the subject matter described in this disclosure can be implemented in a non-transitory computer-readable medium. The non-transitory computer-readable medium may store one or more instructions for wireless communication. The one or more instructions, when executed by one or more processors of a BS, may cause the one or more processors to determine an uplink spatial relationship parameter associated with an uplink TCI state and transmit a communication via a non-serving neighbor cell to indicate the parameter.

Another innovative aspect of the subject matter described in this disclosure can be implemented in an apparatus for wireless communication. The apparatus may include means for determining an uplink spatial relationship parameter associated with an uplink TCI state and means for transmitting a communication via a non-serving neighbor cell to indicate the parameter.

Aspects generally include a method, apparatus, system, computer program product, non-transitory computer-readable medium, user equipment, base station, wireless communication device, or processing system as substantially described herein with reference to and as illustrated by the accompanying drawings.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram illustrating an example of a wireless network.

FIG. 2 is a diagram illustrating an example of a base station (BS) in communication with a user equipment (UE) in a wireless network.

FIG. 3 is a diagram illustrating an example of beamforming architecture that supports beamforming for millimeter wave (mmW) communications.

FIG. 4 is a diagram illustrating an example of using beams for communications between a BS and a UE.

FIG. 5 is a diagram illustrating an example associated with transmitting and receiving transmission configuration indicators (TCIs) for joint downlink/uplink beams.

FIG. 6 is a diagram illustrating an example process performed, for example, by a UE.

FIG. 7 is a diagram illustrating an example process performed, for example, by a BS.

FIGS. 8-9 are block diagrams of example apparatuses for wireless communication.

FIGS. 10-11 are diagrams illustrating example processes performed, for example, by a UE.

FIGS. 12-13 are diagrams illustrating example processes performed, for example, by a BS.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving radio frequency signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

In some situations, a user equipment (UE) may decode a downlink transmission, from a base station (BS), using a transmission configuration indicator (TCI), such as a TCI-State, as defined in the 3GPP specifications, or another similar data structure. The TCI may indicate one or more quasi-co-location (QCL) rules, where a rule associates a reference signal (for example, a synchronization signal, such as a synchronization signal block (SSB); a channel state information (CSI) reference signal (CSI-RS); a positioning reference signal (PRS); or other reference signal) with an associated channel property (for example, a Doppler shift; a Doppler spread; an average delay; a delay spread; one or more spatial parameters, such as a spatial filter; or other properties). Such QCL rules may include QCL-TypeA, QCL-TypeB, QCL-TypeC, or QCL-TypeD data structures as defined by the 3GPP specifications.

Some standards (such as the 3GPP specifications) define a TCI for downlink communications from the BS to the UE. However, the BS and the UE generally manage uplink communications separately, which requires additional processing time as well as signaling and network overhead. Additionally, some standards (such as the 3GPP specifications) define a TCI with no more than two QCL rules.

As described herein, a BS may transmit a TCI that indicates one or more reference signals providing a UE with properties for a common beam. A beam may be “common” when the beam is used by the UE to transmit data or control information on an uplink as well as used by the UE to receive data or control information on a downlink. A TCI state that indicates properties for a common beam may be referred to as a joint downlink and uplink TCI state.

Particular implementations of the subject matter described in this disclosure can be implemented to realize one or more of the following potential advantages. Accordingly, the UE and the BS may reduce signaling and network overhead by using a single TCI (also referred to as a joint TCI) to indicate QCL rules for both uplink and downlink. The joint TCI may enable a unified TCI framework that may simplify a beam management procedure for not only downlink and uplink channels but also for data and control channels in a 3GPP New Radio (NR) system.

Additionally, in some aspects, the joint TCI may indicate more than two QCL rules. For example, the joint TCI may indicate three or more QCL rules to provide properties of the common beam for uplink and downlink. Additionally, or alternatively, the joint TCI may indicate three or more QCL rules to provide properties for a plurality of common beams, each common beam being used for uplink and downlink. Accordingly, the UE and the BS may further reduce signaling and network overhead.

Additionally, in some aspects, the UE may use the joint TCI in determining information regarding communications with one or more BSs, such as in an inter-cell mobility scenario. In a joint TCI inter-cell mobility scenario, the BS may be a non-serving neighbor cell BS for the UE, and the joint TCI may indicate a common beam applicable to both downlink and uplink communication on the non-serving neighbor cell. The joint TCI may improve the inter-cell mobility procedure. For example, the BS may reduce latency in inter-cell handovers by providing the joint TCI state for a neighboring cell in advance of the handover.

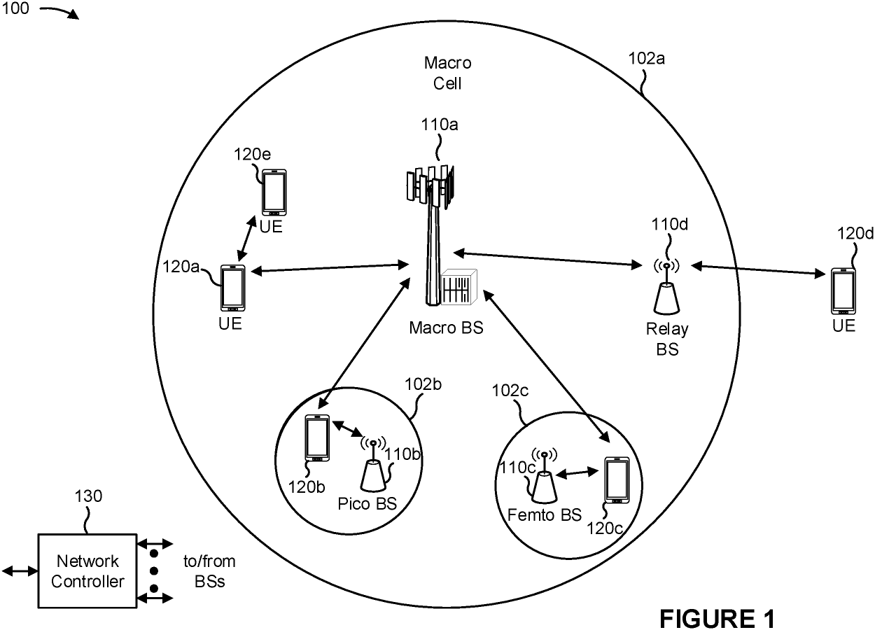

FIG. 1 is a diagram illustrating an example of a wireless network 100. The wireless network 100 may be or may include elements of a 5G (NR) network, an LTE network, or another type of network. The wireless network 100 may include one or more base stations 110 (shown as BS 110a, BS 110b, BS 110c, and BS 110d) and other network entities. A BS is an entity that communicates with UEs and also may be referred to as an NR BS, a Node B, a gNB, a 5G node B (NB), an access point, or a transmit receive point (TRP). Each BS may provide communication coverage for a particular geographic area. In 3GPP, the term “cell” can refer to a coverage area of a BS, a BS subsystem serving this coverage area, or a combination thereof, depending on the context in which the term is used.

A BS may provide communication coverage for a macro cell, a pico cell, a femto cell, another type of cell, or a combination thereof. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (for example, three) cells. The terms “eNB”, “base station”, “NR BS”, “gNB”, “TRP”, “AP”, “node B”, “5G NB”, and “cell” may be used interchangeably herein.

In some examples, a cell may not necessarily be stationary, and the geographic area of the cell may move according to the location of a mobile BS. In some examples, the BSs may be interconnected to one another as well as to one or more other BSs or network nodes (not shown) in the wireless network 100 through various types of backhaul interfaces, such as a direct physical connection, a virtual network, or a combination thereof using any suitable transport network.

The wireless network 100 may include relay stations. A relay station is an entity that can receive a transmission of data from an upstream station (for example, a BS or a UE) and send a transmission of the data to a downstream station (for example, a UE or a BS). A relay station also may be a UE that can relay transmissions for other UEs. In the example shown in FIG. 1, a relay BS 110d may communicate with a macro BS 110a and a UE 120d in order to facilitate communication between the macro BS 110a and the UE 120d. A relay BS also may be referred to as a relay station, a relay base station, a relay, etc.

The wireless network 100 may be a heterogeneous network that includes BSs of different types, for example, macro BSs, pico BSs, femto BSs, relay BSs, etc. These different types of BSs may have different transmit power levels, different coverage areas, and different impacts on interference in the wireless network 100. For example, macro BSs may have a high transmit power level (for example, 5 to 40 watts) whereas pico BSs, femto BSs, and relay BSs may have lower transmit power levels (for example, 0.1 to 2 watts).

A network controller 130 may couple to a set of BSs and may provide coordination and control for these BSs. The network controller 130 may communicate with the BSs via a backhaul. The BSs also may communicate with one another, for example, directly or indirectly via a wireless or wireline backhaul.

Multiple UEs 120 (for example, a UE 120a, a UE 120b, a UE 120c, etc.) may be dispersed throughout the wireless network 100, and each UE may be stationary or mobile. A UE also may be referred to as an access terminal, a terminal, a mobile station, a subscriber unit, a station, etc. A UE may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (for example, smart ring, smart bracelet)), an entertainment device (for example, a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, etc., that may communicate with a base station, another device (for example, remote device), or some other entity. A wireless node may provide, for example, connectivity for or to a network (for example, a wide area network such as Internet or a cellular network) via a wired or wireless communication link. Some UEs may be considered Internet-of-Things (IoT) devices or may be implemented as NB-IoT (narrowband internet of things) devices. Some UEs may be considered a Customer Premises Equipment (CPE). A UE 120 may be included inside a housing that houses components of the UE 120, such as processor components, memory components, or other components. In some examples, the processor components and the memory components may be coupled together. For example, the processor components (for example, one or more processors) and the memory components (for example, a memory) may be operatively coupled, communicatively coupled, electronically coupled, or electrically coupled, among other examples.

In general, any number of wireless networks may be deployed in a given geographic area. Each wireless network may support a particular RAT and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between wireless networks of different RATs. In some cases, NR or 5G RAT networks may be deployed.

In some aspects, two or more UEs 120 (for example, shown as a UE 120a and a UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (which may include a vehicle-to-vehicle (V2V) protocol, a vehicle-to-infrastructure (V2I) protocol, or similar protocol), a mesh network, or similar networks, or combinations thereof. In such examples, the UE 120 may perform scheduling operations, resource selection operations, as well as other operations described elsewhere herein as being performed by the base station 110.

Devices of the wireless network 100 may communicate using the electromagnetic spectrum, which may be subdivided based on frequency or wavelength into various classes, bands, or channels. For example, devices of the wireless network 100 may communicate using an operating band having a first frequency range (FR1), which may span from 410 MHz to 7.125 GHz. As another example, devices of the wireless network 100 may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz - 300 GHz) which is identified by the International Telecommunications Union (ITU) as a “millimeter wave” band. Thus, unless specifically stated otherwise, it should be understood that the term “sub-6 GHz” may broadly represent frequencies less than 6 GHz, frequencies within FR1, mid-band frequencies (for example, greater than 7.125 GHz), or a combination thereof. Similarly, unless specifically stated otherwise, it should be understood that the term “millimeter wave” may broadly represent frequencies within the EHF band, frequencies within FR2, mid-band frequencies (for example, less than 24.25 GHz), or a combination thereof. It is contemplated that the frequencies included in FR1 and FR2 may be modified, and techniques described herein are applicable to those modified frequency ranges.

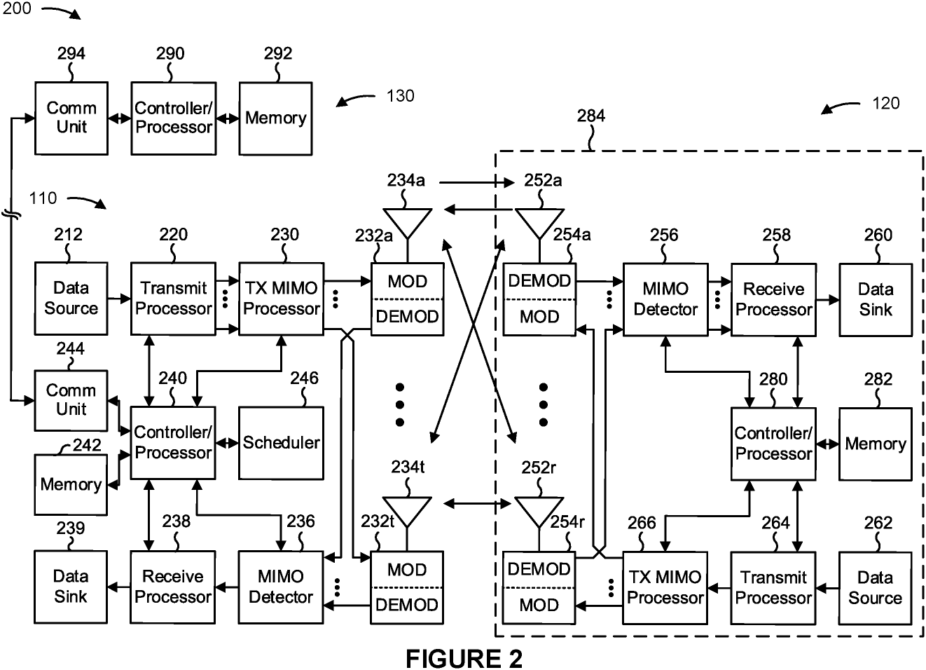

FIG. 2 is a diagram illustrating an example 200 of a base station 110 in communication with a UE 120 in a wireless network 100. The base station 110 may be equipped with T antennas 234a through 234t, and the UE 120 may be equipped with R antennas 252a through 252r, where in general T ≥ 1 and R ≥ 1.

At the base station 110, a transmit processor 220 may receive data from a data source 212 for one or more UEs, select one or more modulation and coding schemes (MCS) for each UE based on channel quality indicators (CQIs) received from the UE, process (for example, encode and modulate) the data for each UE based on the MCS(s) selected for the UE, and provide data symbols for all UEs. The transmit processor 220 also may process system information and control information (for example, CQI requests, grants, upper layer signaling, etc.) and provide overhead symbols and control symbols. The transmit processor 220 also may generate reference symbols for reference signals and synchronization. A transmit (TX) multiple-input multiple-output (MIMO) processor 230 may perform spatial processing (for example, precoding) on the data symbols, the control symbols, the overhead symbols, or the reference symbols, if applicable, and may provide T output symbol streams to T modulators (MODs) 232a through 232t. Each modulator 232 may process a respective output symbol stream (for example, for OFDM, etc.) to obtain an output sample stream. Each modulator 232 may further process (for example, convert to analog, amplify, filter, and upconvert) the output sample stream to obtain a downlink signal. T downlink signals from the modulators 232a through 232t may be transmitted via T antennas 234a through 234t, respectively.

At the UE 120, the antennas 252a through 252r may receive the downlink signals from the base station 110 or other base stations and may provide received signals to the demodulators (DEMODs) 254a through 254r, respectively. Each demodulator 254 may condition (for example, filter, amplify, downconvert, and digitize) a received signal to obtain input samples. Each demodulator 254 may further process the input samples (for example, for OFDM, etc.) to obtain received symbols. A MIMO detector 256 may obtain received symbols from all R demodulators 254a through 254r, perform MIMO detection on the received symbols if applicable, and provide detected symbols. A receive processor 258 may process (for example, demodulate and decode) the detected symbols, provide decoded data for the UE 120 to a data sink 260, and provide decoded control information and system information to a controller/processor 280. The term “controller/processor” may refer to one or more controllers, one or more processors, or a combination thereof. A channel processor may determine reference signal received power (RSRP), received signal strength indicator (RSSI), reference signal received quality (RSRQ), channel quality indicator (CQI), etc. In some aspects, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the base station 110 via the communication unit 294.

On the uplink, at the UE 120, a transmit processor 264 may receive and process data from a data source 262 and control information (for example, for reports including RSRP, RSSI, RSRQ, CQI, etc.) from a controller/processor 280. The transmit processor 264 also may generate reference symbols for one or more reference signals. The symbols from the transmit processor 264 may be precoded by a TX MIMO processor 266 if applicable, further processed by the modulators 254a through 254r (for example, for DFT-s-OFDM, CP-OFDM, etc.), and transmitted to the base station 110. In some aspects, the UE 120 includes a transceiver. The transceiver may include any combination of the antenna(s) 252, the modulators 254, the demodulators 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein.

At the base station 110, the uplink signals from the UE 120 and other UEs may be received by the antennas 234, processed by the demodulators 232, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include a communication unit 244 and may communicate with the network controller 130 via the communication unit 244. The base station 110 may include a scheduler 246 to schedule one or more UEs 120 for downlink communications, uplink communications, or a combination thereof. In some aspects, the base station 110 includes a transceiver. The transceiver may include any combination of the antenna(s) 234, the modulators 232, the demodulators 232, the MIMO detector 236, the receive processor 238, the transmit processor 220, or the TX MIMO processor 230. The transceiver may be used by a processor (for example, the controller/processor 240) and a memory 242 to perform aspects of any of the processes described herein.

In some implementations, the controller/processor 280 may be a component of a processing system. A processing system may generally refer to a system or series of machines or components that receives inputs and processes the inputs to produce a set of outputs (which may be passed to other systems or components of, for example, the UE 120). For example, a processing system of the UE 120 may refer to a system including the various other components or subcomponents of the UE 120.

The processing system of the UE 120 may interface with other components of the UE 120, and may process information received from other components (such as inputs or signals), output information to other components, etc. For example, a chip or modem of the UE 120 may include a processing system, a first interface to receive or obtain information, and a second interface to output, transmit or provide information. In some cases, the first interface may refer to an interface between the processing system of the chip or modem and a receiver, such that the UE 120 may receive information or signal inputs, and the information may be passed to the processing system. In some cases, the second interface may refer to an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit or provide information.

In some implementations, the controller/processor 240 may be a component of a processing system. A processing system may generally refer to a system or series of machines or components that receives inputs and processes the inputs to produce a set of outputs (which may be passed to other systems or components of, for example, the base station 110). For example, a processing system of the base station 110 may refer to a system including the various other components or subcomponents of the base station 110.

The processing system of the base station 110 may interface with other components of the base station 110, and may process information received from other components (such as inputs or signals), output information to other components, etc. For example, a chip or modem of the base station 110 may include a processing system, a first interface to receive or obtain information, and a second interface to output, transmit or provide information. In some cases, the first interface may refer to an interface between the processing system of the chip or modem and a receiver, such that the base station 110 may receive information or signal inputs, and the information may be passed to the processing system. In some cases, the second interface may refer to an interface between the processing system of the chip or modem and a transmitter, such that the base station 110 may transmit information output from the chip or modem. A person having ordinary skill in the art will readily recognize that the second interface also may obtain or receive information or signal inputs, and the first interface also may output, transmit or provide information.

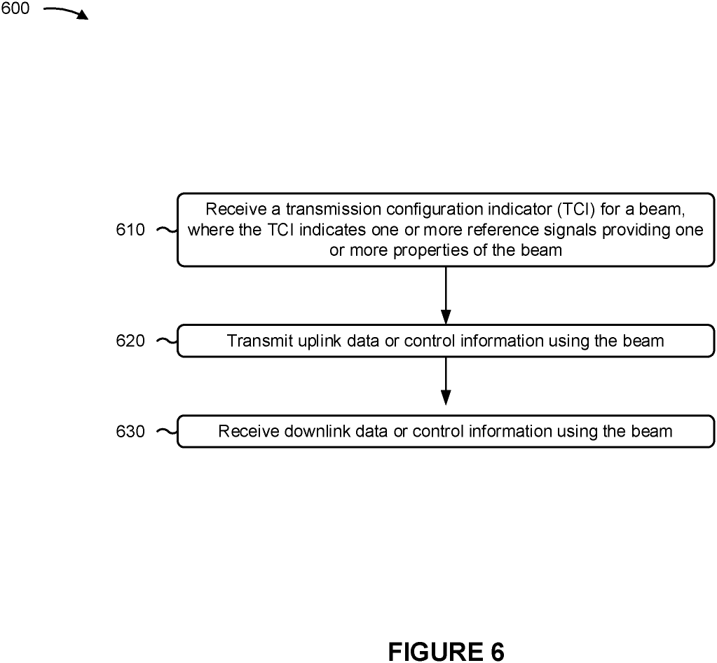

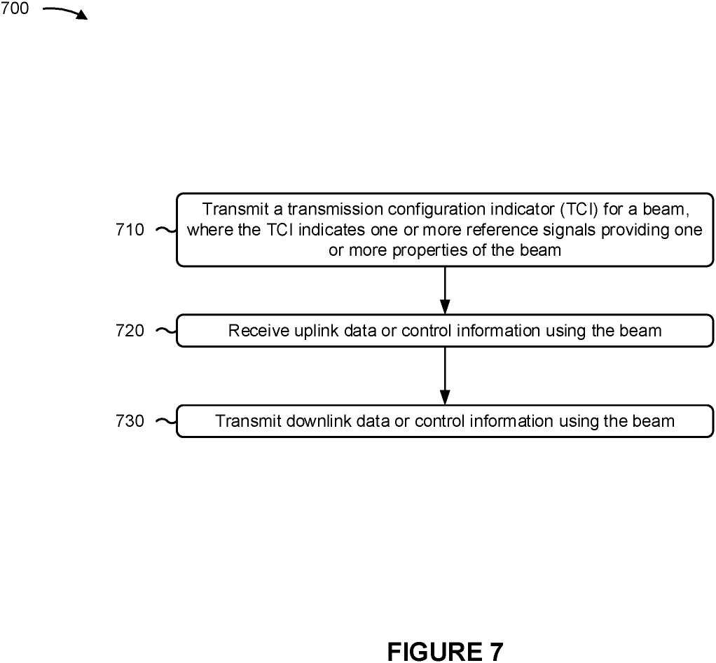

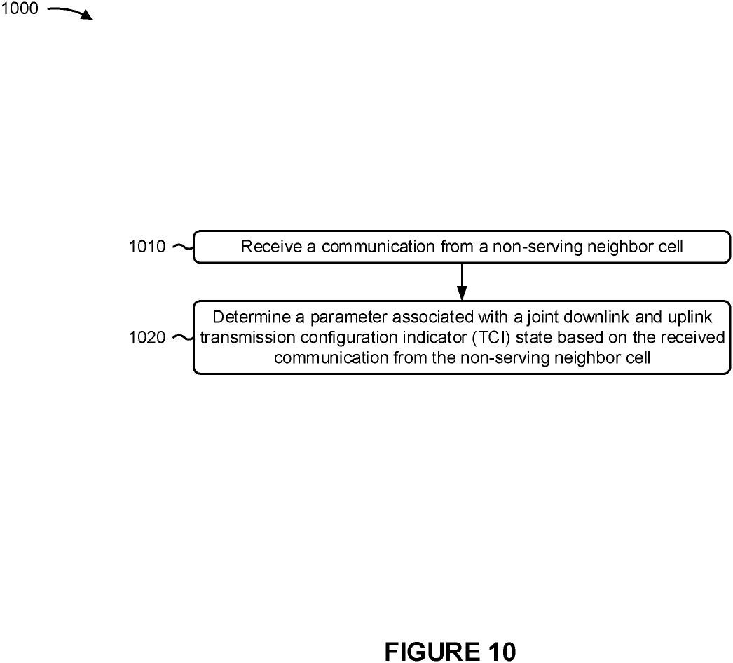

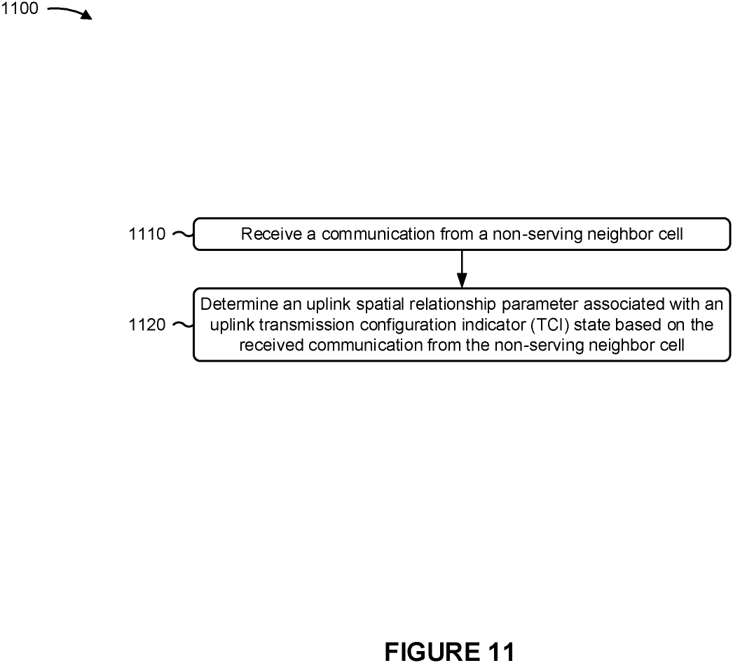

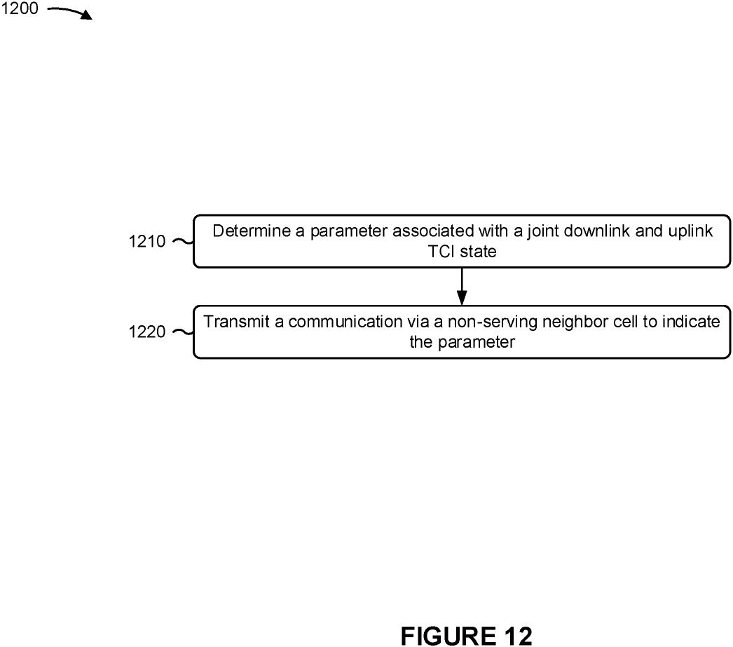

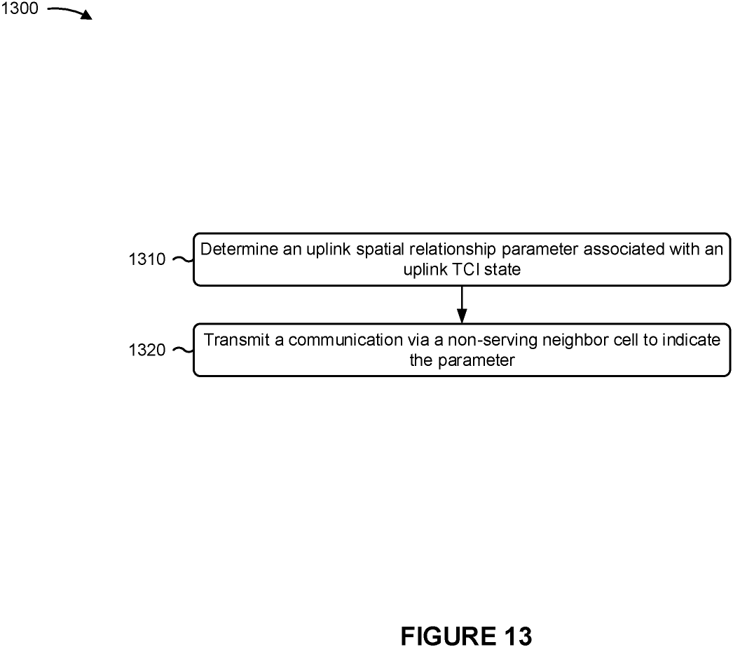

The controller/processor 240 of the base station 110, the controller/processor 280 of the UE 120, or any other component(s) of FIG. 2 may perform one or more techniques associated with transmitting and receiving transmission configuration indicators for joint downlink/uplink beams, as described in more detail elsewhere herein. For example, the controller/processor 240 of the base station 110, the controller/processor 280 of the UE 120, or any other component(s) (or combinations of components) of FIG. 2 may perform or direct operations of, for example, process 600 of FIG. 6, process 700 of FIG. 7, process 1000 of FIG. 10, process 1100 of FIG. 11, process 1200 of FIG. 12, process 1300 of FIG. 13, or other processes as described herein. The memory 242 and the memory 282 may store data and program codes for the base station 110 and the UE 120, respectively. In some aspects, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the base station 110 or the UE 120, may cause the one or more processors, the UE 120, or the base station 110 to perform or direct operations of, for example, process 600 of FIG. 6, process 700 of FIG. 7, process 1000 of FIG. 10, process 1100 of FIG. 11, process 1200 of FIG. 12, process 1300 of FIG. 13, or other processes as described herein.

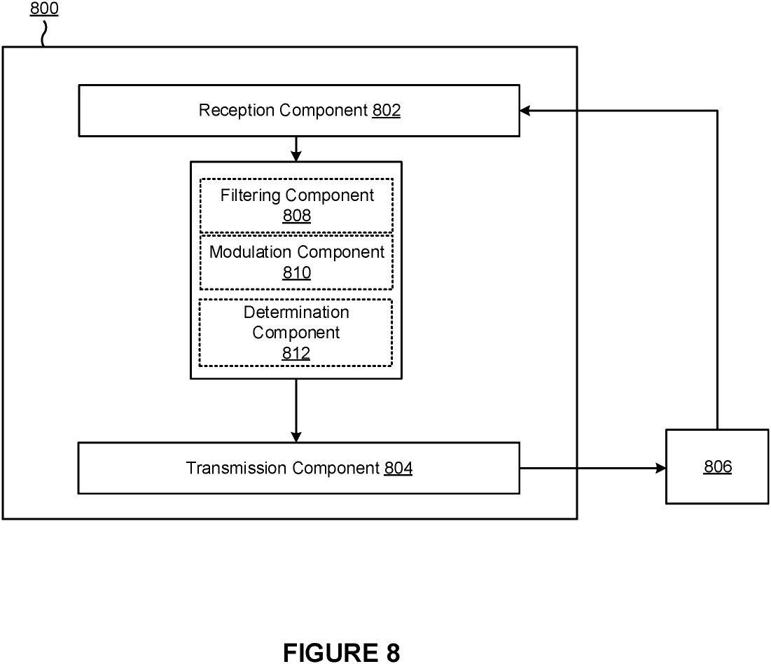

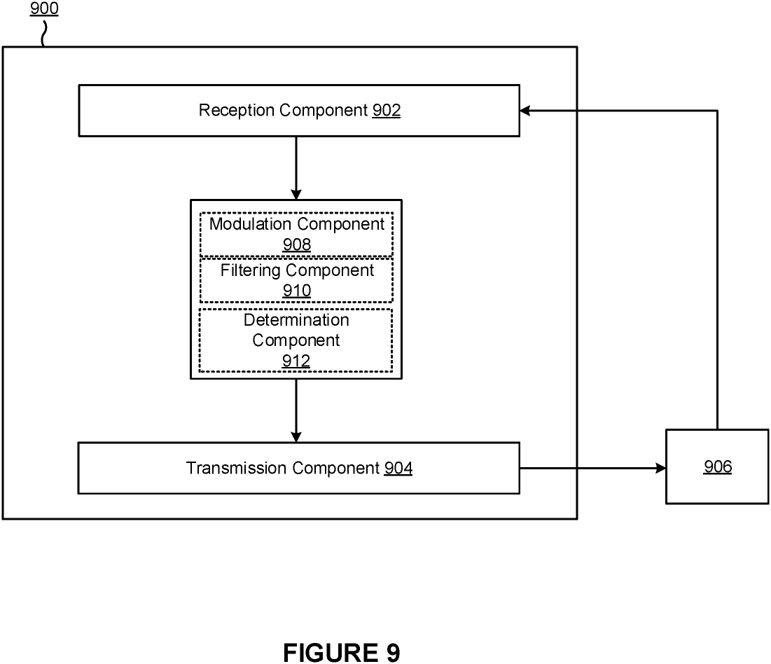

In some aspects, a UE (such as UE 120 or apparatus 800 of FIG. 8) includes means for receiving, from a BS (such as BS 110 or apparatus 900 of FIG. 9), a TCI for a beam, where the TCI indicates one or more reference signals providing one or more properties of the beam; means for transmitting, to the BS, uplink data or control information using the beam; or means for receiving, from the BS, downlink data or control information using the beam. The means for the UE to perform operations described herein may include, for example, transmit processor 220, TX MIMO processor 230, modulator 232, antenna 234, demodulator 232, MIMO detector 236, receive processor 238, controller/processor 240, memory 242, or scheduler 246; or antenna 252, demodulator 254, MIMO detector 256, receive processor 258, transmit processor 264, TX MIMO processor 266, modulator 254, controller/processor 280, or memory 282.

In some aspects, a BS (such as BS 110 or apparatus 900 of FIG. 9) includes means for transmitting, to a UE (such as UE 120 or apparatus 800 of FIG. 8), a TCI for a beam, where the TCI indicates one or more reference signals providing one or more properties of the beam; means for receiving, from the UE, uplink data or control information using the beam; or means for transmitting, to the UE, downlink data or control information using the beam. The means for the base station to perform operations described herein may include, for example, transmit processor 220, TX MIMO processor 230, modulator 232, antenna 234, demodulator 232, MIMO detector 236, receive processor 238, controller/processor 240, memory 242, or scheduler 246; or antenna 252, demodulator 254, MIMO detector 256, receive processor 258, transmit processor 264, TX MIMO processor 266, modulator 254, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, the TX MIMO processor 266, or another processor may be performed by or under the control of the controller/processor 280.

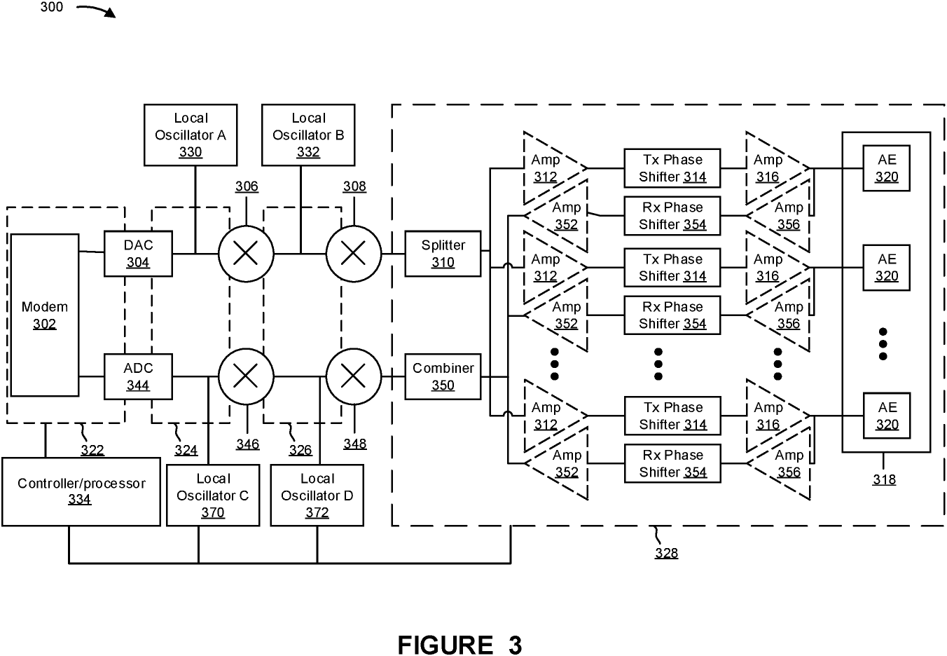

FIG. 3 is a diagram illustrating an example beamforming architecture 300 that supports beamforming for millimeter wave (mmW) communications. In some aspects, architecture 300 may implement aspects of wireless network 100. In some aspects, architecture 300 may be implemented in a transmitting device (such as a first wireless communication device, UE, or base station) or a receiving device (such as a second wireless communication device, UE, or BS), as described herein.

Broadly, FIG. 3 is a diagram illustrating example hardware components of a wireless communication device in accordance with certain aspects of the disclosure. The illustrated components may include those that may be used for antenna element selection or for beamforming for transmission of wireless signals. There are numerous architectures for antenna element selection and implementing phase shifting, only one example of which is illustrated here. The architecture 300 includes a modem (modulator/demodulator) 302, a digital to analog converter (DAC) 304, a first mixer 306, a second mixer 308, and a splitter 310. The architecture 300 also includes multiple first amplifiers 312, multiple phase shifters 314, multiple second amplifiers 316, and an antenna array 318 that includes multiple antenna elements 320.

Transmission lines or other waveguides, wires, traces, or similar connections are shown connecting the various components to illustrate how signals to be transmitted may travel between components. Reference numbers 322, 324, 326, and 328 indicate regions in the architecture 300 in which different types of signals travel or are processed. Specifically, reference number 322 indicates a region in which digital baseband signals travel or are processed, reference number 324 indicates a region in which analog baseband signals travel or are processed, reference number 326 indicates a region in which analog intermediate frequency (IF) signals travel or are processed, and reference number 328 indicates a region in which analog radio frequency (RF) signals travel or are processed. The architecture also includes a local oscillator A 330, a local oscillator B 332, and a controller/processor 334. In some aspects, controller/processor 334 corresponds to controller/processor 240 of the base station described above in connection with FIG. 2 or controller/processor 280 of the UE described above in connection with FIG. 2.

Each of the antenna elements 320 may include one or more sub-elements for radiating or receiving RF signals. For example, a single antenna element 320 may include a first sub-element cross-polarized with a second sub-element that can be used to independently transmit cross-polarized signals. The antenna elements 320 may include patch antennas, dipole antennas, or other types of antennas arranged in a linear pattern, a two dimensional pattern, or another pattern. A spacing between antenna elements 320 may be such that signals with a desired wavelength transmitted separately by the antenna elements 320 may interact or interfere (such as to form a desired beam). For example, given an expected range of wavelengths or frequencies, the spacing may provide a quarter wavelength, half wavelength, or other fraction of a wavelength of spacing between neighboring antenna elements 320 to allow for interaction or interference of signals transmitted by the separate antenna elements 320 within that expected range.

The modem 302 processes and generates digital baseband signals and may also control operation of the DAC 304, first and second mixers 306 and 308, splitter 310, first amplifiers 312, phase shifters 314, or the second amplifiers 316 to transmit signals via one or more or all of the antenna elements 320. The modem 302 may process signals and control operation in accordance with a communication standard such as a wireless standard discussed herein. The DAC 304 may convert digital baseband signals received from the modem 302 (and that are to be transmitted) into analog baseband signals. The first mixer 306 upconverts analog baseband signals to analog IF signals within an IF using a local oscillator A 330. For example, the first mixer 306 may mix the signals with an oscillating signal generated by the local oscillator A 330 to “move” the baseband analog signals to the IF. In some cases, some processing or filtering (not shown) may take place at the IF. The second mixer 308 upconverts the analog IF signals to analog RF signals using the local oscillator B 332. Similar to the first mixer, the second mixer 308 may mix the signals with an oscillating signal generated by the local oscillator B 332 to “move” the IF analog signals to the RF or the frequency at which signals will be transmitted or received. The modem 302 or the controller/processor 334 may adjust the frequency of local oscillator A 330 or the local oscillator B 332 so that a desired IF or RF frequency is produced and used to facilitate processing and transmission of a signal within a desired bandwidth.

In the illustrated architecture 300, signals upconverted by the second mixer 308 are split or duplicated into multiple signals by the splitter 310. The splitter 310 in architecture 300 splits the RF signal into multiple identical or nearly identical RF signals. In other examples, the split may take place with any type of signal, including with baseband digital, baseband analog, or IF analog signals. Each of these signals may correspond to an antenna element 320, and the signal travels through and is processed by amplifiers 312 and 316, phase shifters 314, or other elements corresponding to the respective antenna element 320 to be provided to and transmitted by the corresponding antenna element 320 of the antenna array 318. In one example, the splitter 310 may be an active splitter that is connected to a power supply and provides some gain so that RF signals exiting the splitter 310 are at a power level equal to or greater than the signal entering the splitter 310. In another example, the splitter 310 is a passive splitter that is not connected to power supply and the RF signals exiting the splitter 310 may be at a power level lower than the RF signal entering the splitter 310.

After being split by the splitter 310, the resulting RF signals may enter an amplifier, such as a first amplifier 312, or a phase shifter 314 corresponding to an antenna element 320. The first and second amplifiers 312 and 316 are illustrated with dashed lines because one or both of them might not be necessary in some aspects. In some aspects, both the first amplifier 312 and second amplifier 316 are present. In some aspects, neither the first amplifier 312 nor the second amplifier 316 is present. In some aspects, one of the two amplifiers 312 and 316 is present but not the other. By way of example, if the splitter 310 is an active splitter, the first amplifier 312 may not be used. By way of further example, if the phase shifter 314 is an active phase shifter that can provide a gain, the second amplifier 316 might not be used.

The amplifiers 312 and 316 may provide a desired level of positive or negative gain. A positive gain (positive dB) may be used to increase an amplitude of a signal for radiation by a specific antenna element 320. A negative gain (negative dB) may be used to decrease an amplitude or suppress radiation of the signal by a specific antenna element. Each of the amplifiers 312 and 316 may be controlled independently (for example, by the modem 302 or the controller/processor 334) to provide independent control of the gain for each antenna element 320. For example, the modem 302 or the controller/processor 334 may have at least one control line connected to each of the splitter 310, first amplifiers 312, phase shifters 314, or second amplifiers 316 that may be used to configure a gain to provide a desired amount of gain for each component and thus each antenna element 320.

The phase shifter 314 may provide a configurable phase shift or phase offset to a corresponding RF signal to be transmitted. The phase shifter 314 may be a passive phase shifter not directly connected to a power supply. Passive phase shifters might introduce some insertion loss. The second amplifier 316 may boost the signal to compensate for the insertion loss. The phase shifter 314 may be an active phase shifter connected to a power supply such that the active phase shifter provides some amount of gain or prevents insertion loss. The settings of each of the phase shifters 314 are independent, meaning that each can be independently set to provide a desired amount of phase shift or the same amount of phase shift or some other configuration. The modem 302 or the controller/processor 334 may have at least one control line connected to each of the phase shifters 314 and which may be used to configure the phase shifters 314 to provide a desired amount of phase shift or phase offset between antenna elements 320.

In the illustrated architecture 300, RF signals received by the antenna elements 320 are provided to one or more first amplifiers 356 to boost the signal strength. The first amplifiers 356 may be connected to the same antenna arrays 318 (such as for time division duplex (TDD) operations). The first amplifiers 356 may be connected to different antenna arrays 318. The boosted RF signal is input into one or more phase shifters 354 to provide a configurable phase shift or phase offset for the corresponding received RF signal to enable reception via one or more Rx beams. The phase shifter 354 may be an active phase shifter or a passive phase shifter. The settings of the phase shifters 354 are independent, meaning that each can be independently set to provide a desired amount of phase shift or the same amount of phase shift or some other configuration. The modem 302 or the controller/processor 334 may have at least one control line connected to each of the phase shifters 354 and which may be used to configure the phase shifters 354 to provide a desired amount of phase shift or phase offset between antenna elements 320 to enable reception via one or more Rx beams.

The outputs of the phase shifters 354 may be input to one or more second amplifiers 352 for signal amplification of the phase shifted received RF signals. The second amplifiers 352 may be individually configured to provide a configured amount of gain. The second amplifiers 352 may be individually configured to provide an amount of gain to ensure that the signals input to combiner 350 have the same magnitude. The amplifiers 352 and 356 are illustrated in dashed lines because they might not be necessary in some aspects. In some aspects, both the amplifier 352 and the amplifier 356 are present. In another aspect, neither the amplifier 352 nor the amplifier 356 are present. In other aspects, one of the amplifiers 352 and 356 is present but not the other.

In the illustrated architecture 300, signals output by the phase shifters 354 (via the amplifiers 352 when present) are combined in combiner 350. The combiner 350 in architecture 300 combines the RF signal into a signal. The combiner 350 may be a passive combiner (for example, not connected to a power source), which may result in some insertion loss. The combiner 350 may be an active combiner (for example, connected to a power source), which may result in some signal gain. When combiner 350 is an active combiner, it may provide a different (such as configurable) amount of gain for each input signal so that the input signals have the same magnitude when they are combined. When combiner 350 is an active combiner, the combiner 350 may not need the second amplifier 352 because the active combiner may provide the signal amplification.

The output of the combiner 350 is input into mixers 348 and 346. Mixers 348 and 346 generally down convert the received RF signal using inputs from local oscillators 372 and 370, respectively, to create intermediate or baseband signals that carry the encoded and modulated information. The output of the mixers 348 and 346 are input into an analog-to-digital converter (ADC) 344 for conversion to analog signals. The analog signals output from ADC 344 is input to modem 302 for baseband processing, such as decoding, de-interleaving, or similar operations.

The architecture 300 is given by way of example only to illustrate an architecture for transmitting or receiving signals. In some cases, the architecture 300 or each portion of the architecture 300 may be repeated multiple times within an architecture to accommodate or provide an arbitrary number of RF chains, antenna elements, or antenna panels. Furthermore, numerous alternate architectures are possible and contemplated. For example, although only a single antenna array 318 is shown, two, three, or more antenna arrays may be included, each with one or more of their own corresponding amplifiers, phase shifters, splitters, mixers, DACs, ADCs, or modems. For example, a single UE may include two, four, or more antenna arrays for transmitting or receiving signals at different physical locations on the UE or in different directions.

Furthermore, mixers, splitters, amplifiers, phase shifters and other components may be located in different signal type areas (for example, represented by different ones of the reference numbers 322, 324, 326, and 328) in different implemented architectures. For example, a split of the signal to be transmitted into multiple signals may take place at the analog RF, analog IF, analog baseband, or digital baseband frequencies in different examples. Similarly, amplification or phase shifts may also take place at different frequencies. For example, in some aspects, one or more of the splitter 310, amplifiers 312 and 316, or phase shifters 314 may be located between the DAC 304 and the first mixer 306 or between the first mixer 306 and the second mixer 308. In one example, the functions of one or more of the components may be combined into one component. For example, the phase shifters 314 may perform amplification to include or replace the first or second amplifiers 312 and 316. By way of another example, a phase shift may be implemented by the second mixer 308 to obviate the need for a separate phase shifter 314. This technique is sometimes called local oscillator (LO) phase shifting. In some aspects of this configuration, there may be multiple IF to RF mixers (such as for each antenna element chain) within the second mixer 308, and the local oscillator B 332 may supply different local oscillator signals (with different phase offsets) to each IF to RF mixer.

The modem 302 or the controller/processor 334 may control one or more of the other components 304 through 372 to select one or more antenna elements 320 or to form beams for transmission of one or more signals. For example, the antenna elements 320 may be individually selected or deselected for transmission of a signal (or signals) by controlling an amplitude of one or more corresponding amplifiers, such as the first amplifiers 312 or the second amplifiers 316. Beamforming includes generation of a beam using multiple signals on different antenna elements, where one or more or all of the multiple signals are shifted in phase relative to each other. The formed beam may carry physical or higher layer reference signals or information. As each signal of the multiple signals is radiated from a respective antenna element 320, the radiated signals interact, interfere (constructive and destructive interference), and amplify each other to form a resulting beam. The shape (such as the amplitude, width, or presence of side lobes) and the direction (such as an angle of the beam relative to a surface of the antenna array 318) can be dynamically controlled by modifying the phase shifts or phase offsets imparted by the phase shifters 314 and amplitudes imparted by the amplifiers 312 and 316 of the multiple signals relative to each other. The controller/processor 334 may be located partially or fully within one or more other components of the architecture 300. For example, the controller/processor 334 may be located within the modem 302 in some aspects.

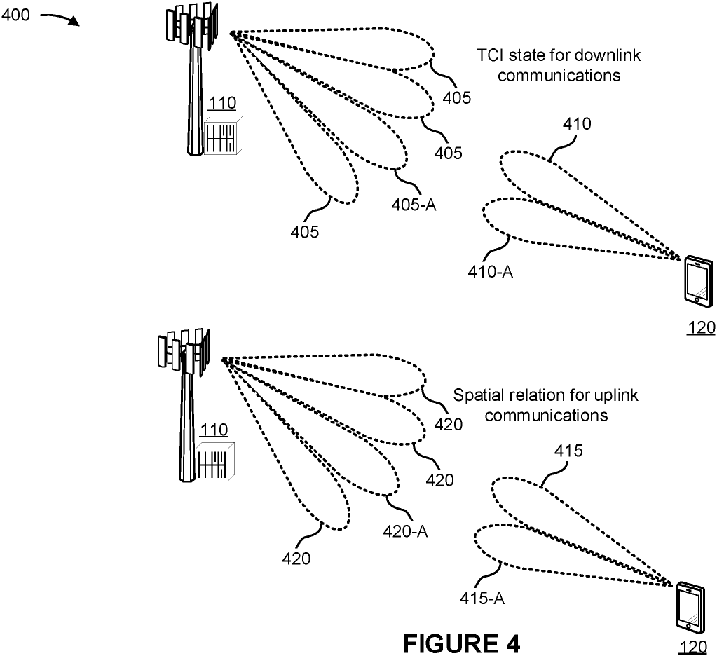

FIG. 4 is a diagram illustrating an example 400 of using beams for communications between a BS and a UE. As shown in FIG. 4, a base station 110 and a UE 120 may communicate with one another.

The base station 110 may transmit to UEs 120 located within a coverage area of the base station 110. The base station 110 and the UE 120 may be configured for beamformed communications, where the base station 110 may transmit in the direction of the UE 120 using a directional BS transmit beam, and the UE 120 may receive the transmission using a directional UE receive beam. Each BS transmit beam may have an associated beam ID, beam direction, or beam symbols, among other examples. The base station 110 may transmit downlink communications via one or more BS transmit beams 405.

The UE 120 may attempt to receive downlink transmissions via one or more UE receive beams 410, which may be configured using different beamforming parameters at receive circuitry of the UE 120. The UE 120 may identify a particular BS transmit beam 405, shown as BS transmit beam 405-A, and a particular UE receive beam 410, shown as UE receive beam 410-A, that provide relatively favorable performance (for example, that have a best channel quality of the different measured combinations of BS transmit beams 405 and UE receive beams 410). In some examples, the UE 120 may transmit an indication of which BS transmit beam 405 is identified by the UE 120 as a preferred BS transmit beam, which the base station 110 may select for transmissions to the UE 120. The UE 120 may thus attain and maintain a beam pair link (BPL) with the base station 110 for downlink communications (for example, a combination of the BS transmit beam 405-A and the UE receive beam 410-A), which may be further refined and maintained in accordance with one or more established beam refinement procedures.

A downlink beam, such as a BS transmit beam 405 or a UE receive beam 410, may be associated with a TCI state. A TCI state may indicate a directionality or a characteristic of the downlink beam, such as one or more QCL properties of the downlink beam. A QCL property may include, for example, a Doppler shift, a Doppler spread, an average delay, a delay spread, or spatial receive parameters, among other examples. In some examples, each BS transmit beam 405 may be associated with a SSB, and the UE 120 may indicate a preferred BS transmit beam 405 by transmitting uplink transmissions in resources of the SSB that are associated with the preferred BS transmit beam 405. A particular SSB may have an associated TCI state (for example, for an antenna port or for beamforming). The base station 110 may, in some examples, indicate a downlink BS transmit beam 405 based on antenna port QCL properties that may be indicated by the TCI state. A TCI state may be associated with one downlink reference signal set (for example, an SSB and an aperiodic, periodic, or semi-persistent CSI-RS) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 410 at the UE 120. Thus, the UE 120 may select a corresponding UE receive beam 410 from a set of BPLs based on the base station 110 indicating a BS transmit beam 405 via a TCI indication.

The base station 110 may maintain a set of activated TCI states for downlink shared channel transmissions and a set of activated TCI states for downlink control channel transmissions. The set of activated TCI states for downlink shared channel transmissions may correspond to beams that the base station 110 uses for downlink transmission on a physical downlink shared channel (PDSCH). The set of activated TCI states for downlink control channel communications may correspond to beams that the base station 110 may use for downlink transmission on a physical downlink control channel (PDCCH) or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as a radio resource control (RRC) message.

Similarly, for uplink communications, the UE 120 may transmit in the direction of the base station 110 using a directional UE transmit beam, and the base station 110 may receive the transmission using a directional BS receive beam. Each UE transmit beam may have an associated beam ID, beam direction, or beam symbols, among other examples. The UE 120 may transmit uplink communications via one or more UE transmit beams 415.

The base station 110 may receive uplink transmissions via one or more BS receive beams 420. The base station 110 may identify a particular UE transmit beam 415, shown as UE transmit beam 415-A, and a particular BS receive beam 420, shown as BS receive beam 420-A, that provide relatively favorable performance (for example, that have a best channel quality of the different measured combinations of UE transmit beams 415 and BS receive beams 420). In some examples, the base station 110 may transmit an indication of which UE transmit beam 415 is identified by the base station 110 as a preferred UE transmit beam, which the base station 110 may select for transmissions from the UE 120. The UE 120 and the base station 110 may thus attain and maintain a BPL for uplink communications (for example, a combination of the UE transmit beam 415-A and the BS receive beam 420-A), which may be further refined and maintained in accordance with one or more established beam refinement procedures. An uplink beam, such as a UE transmit beam 415 or a BS receive beam 420, may be associated with a spatial relation. A spatial relation may indicate a directionality or a characteristic of the uplink beam, similar to one or more QCL properties, as described above.

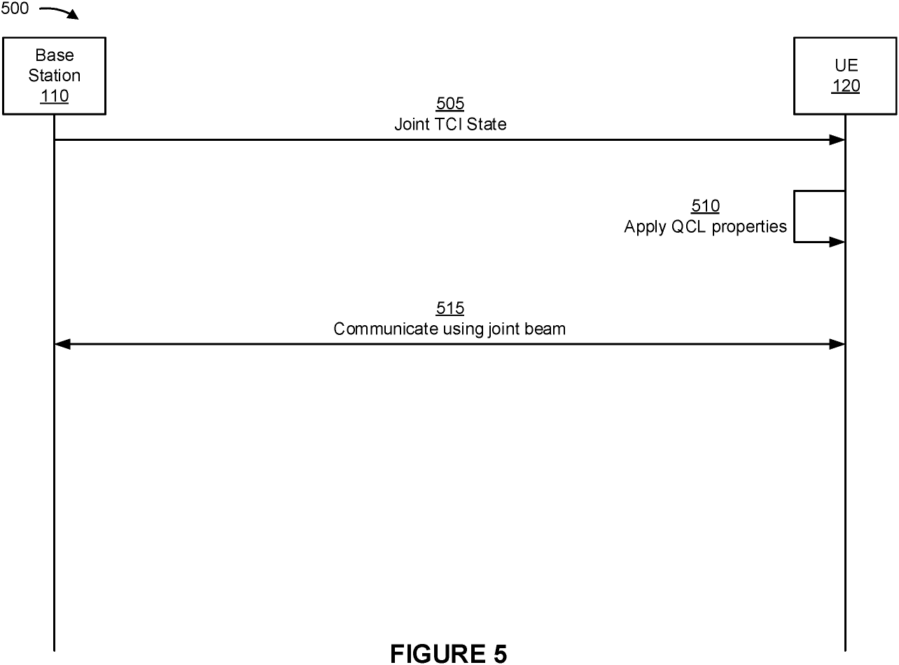

FIG. 5 is a diagram illustrating an example 500 associated with transmitting and receiving transmission configuration indicators for joint downlink/uplink beams. As shown in FIG. 5, a BS 110 and a UE 120 may communicate with one another, such as over wireless network 100 of FIG. 1. The BS 110 may send data or control information to the UE 120 over a downlink, and the UE 120 may send data or control information to the BS 110 over an uplink.

As shown by reference number 505, the BS 110 may transmit, and the UE 120 may receive, a TCI for a beam, where the TCI indicates one or more reference signals providing one or more properties of the beam. For example, the BS 110 may transmit, and the UE 120 may receive, a TCI-State data structure, as defined by the 3GPP specifications, or other similar data structure. The beam may be a common beam such that the UE 120 may use the beam to receive downlink data or control information and to transmit uplink data or control information (also referred to as a joint beam or a joint UL/DL beam).

In some aspects, the TCI may include an identifier (ID). For example, the ID may be alphanumeric, hexadecimal, or other data type including information that identifies the TCI. In some aspects, the identifier may be in a field for common beam configurations. As an alternative, the identifier may be in a field shared between common beam configurations, downlink beam configurations, and uplink beam configurations. For example, the identifier may be included in a tci-StateId field as defined by the 3GPP specifications, or other similar data field.

The one or more reference signals, indicated by the TCI, may include a synchronization signal (such as an SSB), a CSI-RS, a sounding reference signal (SRS), a position reference signal (PRS), a physical random access channel (PRACH), a demodulation reference signal (DMRS), or a combination thereof. The DMRS may include a DMRS for a PDSCH, a PDCCH, a physical uplink shared channel (PUSCH), a physical uplink control channel (PUCCH), or other similar channel. In some aspects, the UE 120 may receive the one or more reference signals in a non-serving neighbor cell. For example, the UE 120 may receive a reference signal providing a downlink QCL rule or an uplink spatial relationship associated with a joint downlink and uplink TCI. Additionally, or alternatively, the UE 120 may receive a reference signal providing uplink spatial relationship information associated with an uplink TCI state. The uplink spatial relationship may provide a spatial transmission filter parameter for transmissions to the UE 120.

The one more reference signals may provide one or more properties for the beam through one or more QCL rules. For example, the TCI may include one or more QCL-Info data structures, as defined by the 3GPP specifications, or other similar data structures, that define the QCL rules. The QCL rules may indicate the one or more properties provided by the one or more reference signals.

The one or more properties for the beam may be spatial, temporal, or otherwise related to a physical property of the beam. For example, the one or more properties may include a Doppler shift (such as when the QCL rule is a QCL-TypeA assumption, a QCL-TypeB assumption, or a QCL-TypeC assumption), a Doppler spread (such as when the QCL rule is a QCL-TypeA assumption or a QCL-TypeB assumption), an average delay (such as when the QCL rule is a QCL-TypeA assumption or a QCL-TypeC assumption), a delay spread (such as when the QCL rule is a QCL-TypeA assumption), a spatial reception filter (such as when the QCL rule is a QCL-TypeD assumption), spatial relation information for transmission, or a combination thereof.

In some aspects, at least one of the one or more reference signals provides at least two spatial properties for the beam. For example, a reference signal may provide both a spatial reception filter, though a QCL-TypeD assumption, and a spatial relation information for transmission. In another example, a reference signal may provide a Doppler shift, a Doppler spread, an average delay, or a delay spread for both uplink and downlink communications on the beam.

In some aspects, the TCI may indicate a plurality of beams. For example, the TCI may indicate a plurality of sets, each set having one or more reference signals, that correspond to the plurality of beams. Accordingly, each beam may be indicated using one or more QCL-Info data structures, as defined by the 3GPP specifications, or other similar data structures, that define QCL rules for that beam. Accordingly, the TCI transmitted by the BS 110 may be larger than the TCI-State data structure as defined in the 3GPP specifications.

In some aspects, the TCI may further indicate at least one cell identifier associated with at least one of the one or more reference signals. The TCI may include a cell data variable, as defined by the 3GPP specifications, or other similar data variable. For example, the TCI may indicate a serving cell identifier of 5-bit length to identify one of the serving cells configured in carrier aggregation for the UE 120, on which the one or more reference signals indicated in the TCI are located. In some aspects, the UE 120 may receive the TCI from the current serving cell, and the TCI may indicate one or more reference signals in a non-serving neighbor cell. The TCI may further indicate a cell identifier for the non-serving neighbor cell associated with the one or more reference signals. In some aspects, the cell identifier for the non-serving neighbor cell may be a physical cell identity (PCI ID), a certain cell ID, an associated SSB set ID, or another identifier associated with the non-serving neighbor cell. The PCI ID for the non-serving neighbor cell in the TCI state may be a full ID, such as a 10-bit PCI ID as defined in the 3GPP specifications. Additionally, or alternatively, the PCI ID for the non-serving neighbor cell in the TCI state may also be a local ID, such as a local 2-bit ID within a set of four PCIs associated with four non-serving neighbor cells configured to the UE 120.

In some aspects, the cell data variable may be indicated for more than one QCL rule (such as in more than one QCL-Info data structure). As described elsewhere herein, the at least one serving cell identifier associated with at least one of the one or more reference signals may be used for inter-radio access technology (RAT) mobility or inter-cell mobility. In some aspects, only some QCL rules (such as QCL-TypeC assumptions or QCL-TypeD assumptions) may be associated with a cell identifier that is not the current serving cell (such as the serving cell including the BS 110). By default (for example, when the cell identifier for serving cell or non-serving cell is not indicated), the UE 120 may apply the TCI to a serving cell in which the TCI is configured, such as the serving cell including the BS 110.

Additionally, or alternatively, the TCI may further indicate at least one bandwidth part (BWP) identifier associated with at least one of the one or more reference signals. For example, the TCI may include a bwp-Id data variable, as defined by the 3GPP specifications, or other similar data variable. By default (for example, when the BWP identifier is not indicated), the UE 120 may apply the TCI to a BWP that is currently active for downlink communications from the BS 110 and a BWP that is currently active for uplink communications to the BS 110.

Additionally, or alternatively, the TCI may further indicate one or more power control parameters for the UE 120 to use when transmitting. The one or more power control parameters may include a pathloss reference signal (such as a CSI-RS or other reference signal), a nominal power parameter (such a P0 or other nominal power), a pathloss scaling factor (such as α or other scaling factor), a close-loop index, an identifier of a power control group (such as a PC group ID), or a combination thereof. In some aspects, as described above, the TCI may indicate a plurality of beams. Accordingly, each beam of the plurality of beams may share the one or more power control parameters. As an alternative, at least one beam of the plurality of beams may use one or more different power control parameters.

Additionally, or alternatively, the TCI may further indicate one or more timing advance (TA) parameters for the UE 120 to use when transmitting. The one or more TA parameters may include a TA value, an identifier of a TA group (such as a TA group ID), or a combination thereof. In some aspects, as described above, the TCI may indicate a plurality of beams. Accordingly, each beam of the plurality of beams may share the one or more TA parameters. As an alternative, at least one beam of the plurality of beams may use one or more different TA parameters.

Additionally, or alternatively, the TCI may further indicate one or more codebook or non-codebook parameters for the UE 120 to use when transmitting. The one or more codebook or non-codebook parameters may include an SRS resource indicator (SRI); a precoding matrix indicator (PMI), such as a transmission PMI (TPMI); a rank indicator (RI), such as a transmission rank indicator (TRI); or a combination thereof. In some aspects, as described above, the TCI may indicate a plurality of beams. Accordingly, each beam of the plurality of beams may share the one or more codebook or non-codebook parameters. As an alternative, at least one beam of the plurality of beams may use one or more different codebook or non-codebook parameters. For example, the codebook parameters may be used in codebook-based uplink MIMO transmissions, and the non-codebook parameters may be used in non-codebook-based uplink MIMO transmissions.

Additionally, or alternatively, the TCI may further indicate one or more identifiers of one or more antenna panels associated with the UE 120. The one or more antenna panels may include a plurality of antenna panels, and each panel may use a different analog beam, a different uplink power control parameter, a different uplink TA parameter, or a combination thereof. In some aspects, the one or more identifiers may include an identifier of an antenna port group (such as an antenna port group ID), an identifier of a beam group (such as a beam group ID), or other identifier.

In some aspects, the one or more identifiers may include at least one identifier associated with downlink communications and at least one identifier associated with uplink communications. Accordingly, the UE 120 may use one or more different antenna panels for uplink communications than downlink communications. Additionally, or alternatively, the UE 120 may use one or more same antenna panels for uplink and downlink communications but associated with different identifiers for uplink communications than downlink communications.

As an alternative, the one or more identifiers include at least one identifier associated with both downlink communications and uplink communications. In some aspects, as described above, the TCI may indicate a plurality of beams. Accordingly, each beam of the plurality of beams may share the one or more identifiers. As an alternative, at least one beam of the plurality of beams may be associated with one or more different identifiers. For example, the UE 120 may use one or more different antenna panels for different beams. Additionally, or alternatively, the UE 120 may use one or more same antenna panels for different beams but associated with different identifiers depending on which beam is used.

As shown by reference number 510, the UE 120 may apply the TCI. For example, the UE 120 may measure the one or more reference signals indicated by the TCI in order to obtain the one or more properties (such as those indicated by one or more QCL rules indicated by the TCI) provided by the one or more reference signals. The UE 120 may adjust one or more antennas, a modulator, a demodulator, or other hardware based on the one or more properties.

As shown by reference number 515, the BS 110 and the UE 120 may communicate using the joint beam indicated by the TCI. For example, the BS 110 may use beamforming hardware (such as that described above in connection with FIG. 3) to transmit downlink data or control information to the UE 120. The UE 120 may use the one or more properties provided by the one or more reference signals (as described above in connection with reference number 510) to receive and decode the downlink data or control information. Similarly, the UE 120 may use beamforming hardware (such as that described above in connection with FIG. 3) to transmit uplink data or control information to the BS 110. The UE 120 may use the one or more properties provided by the one or more reference signals (as described above in connection with reference number 510) to encode and transmit the uplink data or control information.

In some aspects, as described above, the TCI may indicate a plurality of beams. Accordingly, the BS 110 and the UE 120 may use each beam of the plurality of beams as a common beam. For example, the UE 120 and the BS 110 may use beamforming hardware (such as that described above in connection with FIG. 3) to exchange uplink data or control information and downlink data or control information consistent with the one or more properties provided by the one or more reference signals.

Accordingly, the techniques and apparatuses described in connection with FIG. 5 may be used to jointly indicate a common beam or a set of common beams applied commonly to each of multiple downlink/uplink (DL/UL) resources. As described above, a joint DL/UL TCI state can be defined with the following contents:

Info 1: TCI state ID. It can be in a dedicated ID space for common beam(s) indication, or in a common ID space shared for common DL/UL beam(s) indication, DL beam only indication, or UL beam only indication

Info 2: One or multiple source RSs to provide various QCL assumptions including characteristics on delay, Doppler, spatial Rx/Tx parameters. Each source RS may have the following RS type: SSB, CSI-RS, SRS, PRS, PRACH, or DMRS of PDSCH, PDCCH, PUCCH, or PUSCH. Each source RS may provide at least one of the following QCL/spatial assumption for DL reception (Rx): ‘QCL-TypeA’: {Doppler shift, Doppler spread, average delay, delay spread}; ‘QCL-TypeB’: {Doppler shift, Doppler spread}; ‘QCL-TypeC’: {Doppler shift, average delay}; or ‘QCL-TypeD’: {Spatial parameter}. Each source RS may provide at least one of the following QCL/spatial assumption for UL transmission (Tx): UL spatial relation info for spatial Tx parameter or UL Doppler shift/spread, average delay, or delay spread, such as UL QCL-TypeA/B/C. Source RS to provide UL QCL-TypeA/B/C may be UL RS for gNB to measure, such as SRS. Each source RS may simultaneously provide multiple QCL assumptions. For example, SSB #5 as source RS #1 may provide both QCL-TypeD in downlink and spatial relation info in uplink for the common beam.

Each source RS may have the following info on its location: serving cell ID and BWP ID, where the RS is located. If the serving cell ID is absent, it applies to the serving cell in which the TCI-State is configured. The RS may be located on a serving cell other than the serving cell in which the TCI-State is configured only if the QCL-Type is configured as TypeC or TypeD. If the BWP ID is absent, it applies to the active DL and UL BWP.

The at least one source RS may have different combinations based on provided QCL/spatial assumptions. For example, to indicate a single common DL/UL beam, the set of source RS(s) may have the following combinations: Example 1: One source RS for QCL-TypeA or B or C, which means the RS is for providing QCL-Type A or B or C; Example 2: Three source RSs with 1st RS for QCL-TypeA/B/C, 2nd RS for QCL-TypeD, 3rd RS for spatial relation info; Example 3: Two source RSs with 1st RS for QCL-TypeA/B/C, 2nd RS for both QCL-TypeD and spatial relation info; or Example 4: Three source RSs with 1st RS for QCL-TypeA/B/C, 2nd RS for both QCL-TypeD and spatial relation info, 3rd RS for UL QCL-TypeA/B/C.

As described above, if the joint TCI state indicates multiple common DL/UL beams, each common DL/UL beam is indicated by one above set of source RS(s).

Info 3: UL power control (PC) parameters including pathloss RS, P0, Alpha, close-loop index, PC group ID, etc., for UL transmission of the common DL/UL beam. If the joint TCI state indicates multiple common DL/UL beams, each common DL/UL beam can have one set of associated UL PC parameters, which can be same or different from other common DL/UL beams.

Info 4: UL timing advance (TA) parameters including TA group ID or TA value for UL transmission of the common DL/UL beam. If the joint TCI state indicates multiple common DL/UL beams, each common DL/UL beam can have one set of associated UL TA parameters, which can be same or different from other common DL/UL beams.

Info 5: Parameters for codebook-/non-codebook-based PUSCH transmission including SRI, TPMI, TRI for PUSCH Tx of the common DL/UL beam. If the joint TCI state indicates multiple common DL/UL beams, each common DL/UL beam can have one set of parameters for CB/NCB based PUSCH transmission.

Info 6: UE panel ID(s) or similar ID(s). UE panel ID(s) associated with the common DL/UL beam can be two separate panel IDs for DL and UL, or a single panel ID for both DL and UL. UE panel can be defined to have independent analog beam, UL PC, or UL timing advance (TA). UE panel ID may also be called as: antenna port group ID, beam group ID, etc. If the joint TCI state indicates multiple common DL/UL beams, each common DL/UL beam can have its own UE panel ID(s).

In some aspects, the RS or channel providing various DL QCL assumptions and/or UL spatial relation information in a joint TCI state for inter-cell mobility may be located in a non-serving neighbor cell. The non-serving neighbor cell may be a different cell where the joint TCI is configured. The joint TCI state indicates a common beam for DL receptions and UL transmissions, and the applicable DL receptions and UL transmissions may be determined in the 3GPP specifications or by the indication of gNB, such as via RRC/MAC-CE/DCI. The RS or channel type may include SSB, CSI-RS, PRS, SRS, PDCCH, PDSCH, PUCCH, PUSCH, or PRACH. The corresponding non-serving neighbor cell ID and BWP ID may be configured for each RS or channel in the joint DL/UL TCI state. The non-serving neighbor cell ID in the joint TCI state may be indicated by its PCI or certain cell ID or SSB set ID.

In some aspects, the RS or channel providing UL spatial relation information in an TCI state for UL transmission for inter-cell mobility may be located in a non-serving neighbor cell. The non-serving neighbor cell may be a different cell where the TCI is configured. The UL TCI state indicates an UL beam for UL transmissions, and the applicable UL transmissions may be determined in the 3GPP specifications or by the indication of gNB, such as via RRC/MAC-CE/DCI. The RS or channel type may include SSB, CSI-RS, PRS, SRS, PDCCH, PDSCH, PUCCH, PUSCH, or PRACH. The corresponding non-serving neighbor cell ID and BWP ID may be configured for each RS/channel in the TCI. The non-serving neighbor cell ID in the TCI for UL may be indicated by its PCI or certain cell ID or SSB set ID.

FIG. 6 is a diagram illustrating an example process 600 performed, for example, by a UE. The process 600 is an example where the UE (for example, UE 120 of FIG. 1 or apparatus 800 of FIG. 8) performs operations associated with receiving a TCI for a joint downlink/uplink beam.

As shown in FIG. 6, in some aspects, the process 600 may include receiving, from a base station (for example, BS 110 of FIG. 1 or apparatus 900 of FIG. 9), a TCI for a beam, where the TCI indicates one or more reference signals providing one or more properties of the beam (block 610). For example, the UE (such as by using reception component 802, depicted in FIG. 8) may receive, from the BS, the TCI for the beam, where the TCI indicates the one or more reference signals providing the one or more properties of the beam, as described herein.

As further shown in FIG. 6, in some aspects, the process 600 may include transmitting, to the BS, uplink data or control information using the beam (block 620). For example, the UE (such as by using transmission component 804, depicted in FIG. 8) may transmit, to the BS, the uplink data or control information using the beam, as described herein.

As further shown in FIG. 6, in some aspects, the process 600 may include receiving, from the BS, downlink data or control information using the beam (block 630). For example, the UE (such as by using reception component 802) may receive, from the BS, the downlink data or control information using the beam, as described herein.

The process 600 may include additional aspects, such as any single aspect or any combination of aspects described below or in connection with one or more other processes described elsewhere herein.

In a first additional aspect, the TCI includes an identifier.

In a second additional aspect, alone or in combination with the first aspect, the identifier is in a field for common beam configurations.

In a third additional aspect, alone or in combination with one or more of the first and second aspects, the identifier is in a field shared between common beam configurations, downlink beam configurations, and uplink beam configurations.

In a fourth additional aspect, alone or in combination with one or more of the first through third aspects, the one or more reference signals include at least one of a synchronization signal, a CSI-RS, an SRS, a PRS, a PRACH signal, a DMRS, or a combination thereof.

In a fifth additional aspect, alone or in combination with one or more of the first through fourth aspects, the one or more properties for the beam include at least one of a Doppler shift, a Doppler spread, an average delay, a delay spread, a spatial reception filter, spatial relation information for transmission, or a combination thereof.

In a sixth additional aspect, alone or in combination with one or more of the first through fifth aspects, at least one of the one or more reference signals provides at least two properties for the beam.

In a seventh additional aspect, alone or in combination with one or more of the first through sixth aspects, the TCI further indicates at least one serving cell identifier associated with at least one of the one or more reference signals.

In an eighth additional aspect, alone or in combination with one or more of the first through seventh aspects, the TCI further indicates at least one BWP identifier associated with at least one of the one or more reference signals.

In a ninth additional aspect, alone or in combination with one or more of the first through eighth aspects, the TCI indicates a plurality of sets, each set having one or more reference signals, that correspond to a plurality of beams.

In a tenth additional aspect, alone or in combination with one or more of the first through ninth aspects, the TCI further indicates one or more power control parameters to use when transmitting.

In an eleventh additional aspect, alone or in combination with one or more of the first through tenth aspects, the one or more power control parameters include at least one of a pathloss reference signal, a nominal power parameter, a pathloss scaling factor, a close-loop index, an identifier of a power control group, or a combination thereof.

In a twelfth additional aspect, alone or in combination with one or more of the first through eleventh aspects, the TCI indicates a plurality of beams, each beam sharing the one or more power control parameters.

In a thirteenth additional aspect, alone or in combination with one or more of the first through twelfth aspects, the TCI indicates a plurality of beams, each beam using different power control parameters.

In a fourteenth additional aspect, alone or in combination with one or more of the first through thirteenth aspects, the TCI further indicates one or more TA parameters to use when transmitting.

In a fifteenth additional aspect, alone or in combination with one or more of the first through fourteenth aspects, the one or more TA parameters include at least one of a TA value, an identifier of a TA group, or a combination thereof.

In a sixteenth additional aspect, alone or in combination with one or more of the first through fifteenth aspects, the TCI indicates a plurality of beams, each beam sharing the one or more TA parameters.

In a seventeenth additional aspect, alone or in combination with one or more of the first through sixteenth aspects, the TCI indicates a plurality of beams, each beam using different TA parameters.

In an eighteenth additional aspect, alone or in combination with one or more of the first through seventeenth aspects, the TCI further indicates one or more codebook or non-codebook parameters to use when transmitting.

In a nineteenth additional aspect, alone or in combination with one or more of the first through eighteenth aspects, the one or more codebook or non-codebook parameters include at least one of an SRI, a PMI, an RI, or a combination thereof.

In a twentieth additional aspect, alone or in combination with one or more of the first through nineteenth aspects, the TCI indicates a plurality of beams, each beam using different codebook or non-codebook parameters.

In a twenty-first additional aspect, alone or in combination with one or more of the first through twentieth aspects, the TCI further indicates one or more identifiers of one or more antenna panels associated with the apparatus of the UE.

In a twenty-second additional aspect, alone or in combination with one or more of the first through twenty-first aspects, the one or more identifiers include at least one identifier associated with downlink communications and at least one identifier associated with uplink communications.

In a twenty-third additional aspect, alone or in combination with one or more of the first through twenty-second aspects, the one or more identifiers include at least one identifier associated with both downlink communications and uplink communications.

In a twenty-fourth additional aspect, alone or in combination with one or more of the first through twenty-third aspects, the one or more identifiers include at least one of an identifier of an antenna port group, or an identifier of a beam group.

In a twenty-fifth additional aspect, alone or in combination with one or more of the first through twenty-fourth aspects, the one or more antenna panels include a plurality of antenna panels, each panel using a different analog beam, uplink power control parameter, uplink timing advance parameter, or a combination thereof.

In a twenty-sixth additional aspect, alone or in combination with one or more of the first through twenty-fifth aspects, the TCI indicates a plurality of beams, each beam being associated with different identifiers of one or more antenna panels associated with the apparatus of the UE.

Although FIG. 6 shows example blocks of the process 600, in some aspects, the process 600 may include additional blocks, fewer blocks, different blocks, or differently arranged blocks than those depicted in FIG. 6. Additionally, or alternatively, two or more of the blocks of the process 600 may be performed in parallel.

FIG. 7 is a diagram illustrating an example process 700 performed, for example, by a BS. The process 700 is an example where the base station (for example, BS 110 of FIG. 1 or apparatus 900 of FIG. 9) performs operations associated with transmitting a TCI for a joint downlink/uplink beam.

As shown in FIG. 7, in some aspects, the process 700 may include transmitting, to a UE (for example, UE 120 or apparatus 800 of FIG. 8), a TCI for a beam, where the TCI indicates one or more reference signals providing one or more properties of the beam (block 710). For example, the base station (such as by using transmission component 904, depicted in FIG. 9) may transmit, to the UE, the TCI for the beam, the TCI indicates the one or more reference signals providing the one or more properties of the beam, as described herein.

As further shown in FIG. 7, in some aspects, the process 700 may include receiving, from the UE, uplink data or control information using the beam (block 720). For example, the base station (such as by using reception component 902, depicted in FIG. 9) may receive, from the UE, the uplink data or control information using the beam, as described herein.

As further shown in FIG. 7, in some aspects, the process 700 may include transmitting, to the UE, downlink data or control information using the beam (block 730). For example, the base station (such as by using transmission component 904) may transmit, to the UE, the downlink data or control information using the beam, as described herein.

The process 700 may include additional aspects, such as any single aspect or any combination of aspects described below or in connection with one or more other processes described elsewhere herein.

In a first additional aspect, the TCI includes an identifier.

In a second additional aspect, alone or in combination with the first aspect, the identifier is in a field for common beam configurations.

In a third additional aspect, alone or in combination with one or more of the first and second aspects, the identifier is in a field shared between common beam configurations, downlink beam configurations, and uplink beam configurations.

In a fourth additional aspect, alone or in combination with one or more of the first through third aspects, the one or more reference signals include at least one of a synchronization signal, a CSI-RS, an SRS, a PRS, a PRACH signal, a DMRS, or a combination thereof.

In a fifth additional aspect, alone or in combination with one or more of the first through fourth aspects, the one or more properties for the beam include at least one of a Doppler shift, a Doppler spread, an average delay, a delay spread, a spatial reception filter, spatial relation information for transmission, or a combination thereof.

In a sixth additional aspect, alone or in combination with one or more of the first through fifth aspects, at least one of the one or more reference signals provides at least two properties for the beam.

In a seventh additional aspect, alone or in combination with one or more of the first through sixth aspects, the TCI further indicates at least one serving cell identifier associated with at least one of the one or more reference signals.

In an eighth additional aspect, alone or in combination with one or more of the first through seventh aspects, the TCI further indicates at least one BWP identifier associated with at least one of the one or more reference signals.

In a ninth additional aspect, alone or in combination with one or more of the first through eighth aspects, the TCI indicates a plurality of sets, each set having one or more reference signals, that correspond to a plurality of beams.

In a tenth additional aspect, alone or in combination with one or more of the first through ninth aspects, the TCI further indicates one or more power control parameters for the UE.

In an eleventh additional aspect, alone or in combination with one or more of the first through tenth aspects, the one or more power control parameters include at least one of a pathloss reference signal, a nominal power parameter, a pathloss scaling factor, a close-loop index, an identifier of a power control group, or a combination thereof.

In a twelfth additional aspect, alone or in combination with one or more of the first through eleventh aspects, the TCI indicates a plurality of beams, each beam sharing the one or more power control parameters.

In a thirteenth additional aspect, alone or in combination with one or more of the first through twelfth aspects, the TCI indicates a plurality of beams, each beam using different power control parameters.

In a fourteenth additional aspect, alone or in combination with one or more of the first through thirteenth aspects, the TCI further indicates one or more TA parameters for the UE.

In a fifteenth additional aspect, alone or in combination with one or more of the first through fourteenth aspects, the one or more TA parameters include at least one of a TA value, an identifier of a TA group, or a combination thereof.

In a sixteenth additional aspect, alone or in combination with one or more of the first through fifteenth aspects, the TCI indicates a plurality of beams, each beam sharing the one or more TA parameters.

In a seventeenth additional aspect, alone or in combination with one or more of the first through sixteenth aspects, the TCI indicates a plurality of beams, each beam using different TA parameters.

In an eighteenth additional aspect, alone or in combination with one or more of the first through seventeenth aspects, the TCI further indicates one or more codebook or non-codebook parameters for the UE.

In a nineteenth additional aspect, alone or in combination with one or more of the first through eighteenth aspects, the one or more codebook or non-codebook parameters include at least one of an SRI, a PMI, an RI, or a combination thereof.

In a twentieth additional aspect, alone or in combination with one or more of the first through nineteenth aspects, the TCI indicates a plurality of beams, each beam using different codebook or non-codebook parameters.

In a twenty-first additional aspect, alone or in combination with one or more of the first through twentieth aspects, the TCI further indicates one or more identifiers of one or more antenna panels associated with the UE.

In a twenty-second additional aspect, alone or in combination with one or more of the first through twenty-first aspects, the one or more identifiers include at least one identifier associated with downlink communications and at least one identifier associated with uplink communications.

In a twenty-third additional aspect, alone or in combination with one or more of the first through twenty-second aspects, the one or more identifiers include at least one identifier associated with both downlink communications and uplink communications.

In a twenty-fourth additional aspect, alone or in combination with one or more of the first through twenty-third aspects, the one or more identifiers include at least one of an identifier of an antenna port group, or an identifier of a beam group.

In a twenty-fifth additional aspect, alone or in combination with one or more of the first through twenty-fourth aspects, the one or more antenna panels include a plurality of antenna panels, each panel using a different analog beam, uplink power control parameter, uplink timing advance parameter, or a combination thereof.

In a twenty-sixth additional aspect, alone or in combination with one or more of the first through twenty-fifth aspects, the TCI indicates a plurality of beams, each beam being associated with different identifiers of one or more antenna panels associated with the UE.

Although FIG. 7 shows example blocks of the process 700, in some aspects, the process 700 may include additional blocks, fewer blocks, different blocks, or differently arranged blocks than those depicted in FIG. 7. Additionally, or alternatively, two or more of the blocks of the process 700 may be performed in parallel.

FIG. 8 is a block diagram of an example apparatus 800 for wireless communication. The apparatus 800 may be a UE, or a UE may include the apparatus 800. In some aspects, the apparatus 800 includes a reception component 802 and a transmission component 804, which may be in communication with one another (for example, via one or more buses or one or more other components). As shown, the apparatus 800 may communicate with another apparatus 806 (such as a UE 120 of FIG. 1, a BS 110 of FIG. 1, or another wireless communication device) using the reception component 802 and the transmission component 804. As further shown, the apparatus 800 may include one or more of a filtering component 808, a modulation component 810, or a determination component 812, among other examples.

In some aspects, the apparatus 800 may be configured to perform one or more operations described herein in connection with FIG. 5. Additionally or alternatively, the apparatus 800 may be configured to perform one or more processes described herein, such as process 600 of FIG. 6, process 1000 of FIG. 10, process 1100 of FIG. 11, or a combination thereof. In some aspects, the apparatus 800 or one or more components shown in FIG. 8 may include one or more components of the UE described above in connection with FIG. 2. Additionally, or alternatively, one or more components shown in FIG. 8 may be implemented within one or more components described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 806. In some aspects, the reception component 802 may include one or more antennas, a demodulator, a MIMO detector, a receive processor, a controller/processor, a memory, or a combination thereof, of the UE described above in connection with FIG. 2.

In some aspects, the reception component 802 may be a component of a processing system. For example, a processing system of the apparatus 800 may refer to a system including the various other components or subcomponents of the apparatus 800.

The transmission component 804 may transmit communications, such as reference signals, control information, data communications, or a combination thereof, to the apparatus 806. In some aspects, one or more other components of the apparatus 806 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modulator, a transmit MIMO processor, a transmit processor, a controller/processor, a memory, or a combination thereof, of the UE described above in connection with FIG. 2. In some aspects, the transmission component 804 may be collocated with the reception component 802 in a transceiver.

In some aspects, the transmission component 804 may be a component of a processing system. For example, a processing system of the apparatus 800 may refer to a system including the various other components or subcomponents of the apparatus 800.

The processing system of the apparatus 800 may interface with other components of the apparatus 800, and may process information received from other components (such as inputs or signals), output information to other components, etc. For example, a chip or modem of the apparatus 800 may include a processing system, the reception component 802 to receive or obtain information, and the transmission component 804 to output, transmit or provide information. In some cases, the reception component 802 may refer to an interface between the processing system of the chip or modem and a receiver, such that the apparatus 800 may receive information or signal inputs, and the information may be passed to the processing system. In some cases, the transmission component 804 may refer to an interface between the processing system of the chip or modem and a transmitter, such that the apparatus 800 may transmit information output from the chip or modem. A person having ordinary skill in the art will readily recognize that the second interface also may obtain or receive information or signal inputs, and the first interface also may output, transmit or provide information.

In some aspects, the reception component 802 may receive, from the apparatus 806, a TCI for a beam, where the TCI indicates one or more reference signals providing one or more properties of the beam. Accordingly, the reception component 802 may receive, from the apparatus 806, downlink data or control information using the beam. For example, the filtering component 808 may filter signals, from the apparatus 806, that encode the downlink data or control information, based on the one or more properties. In some aspects, the filtering component 808 may include one or more antennas, a demodulator, a MIMO detector, a receive processor, a controller/processor, a memory, or a combination thereof, of the UE described above in connection with FIG. 2.

In some aspects, the determination component 812 may determine a parameter associated with a joint downlink and uplink TCI or an uplink spatial relationship parameter associated with an uplink TCI, among other examples. In some aspects, the determination component 812 may include a transmit processor, a receive processor, a controller/processor, a memory, or a combination thereof, of the UE described above in connection with FIG. 2.

Additionally, the transmission component 804 may transmit, to the apparatus 806, uplink data or control information using the beam. For example, the modulation component 810 may encode the uplink data or control information based on the one or more properties. In some aspects, the modulation component 810 may include one or more antennas, a modulator, a transmit MIMO processor, a transmit processor, a controller/processor, a memory, or a combination thereof, of the UE described above in connection with FIG. 2.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

FIG. 9 is a block diagram of an example apparatus 900 for wireless communication. The apparatus 900 may be a base station, or a base station may include the apparatus 900. In some aspects, the apparatus 900 includes a reception component 902 and a transmission component 904, which may be in communication with one another (for example, via one or more buses or one or more other components). As shown, the apparatus 900 may communicate with another apparatus 906 (such as a UE 120 of FIG. 1, a BS 110 of FIG. 1, or another wireless communication device) using the reception component 902 and the transmission component 904. As further shown, the apparatus 900 may include one or more of a modulation component 908 or a filtering component 910, among other examples.

In some aspects, the apparatus 900 may be configured to perform one or more operations described herein in connection with FIG. 5. Additionally or alternatively, the apparatus 900 may be configured to perform one or more processes described herein, such as process 700 of FIG. 7, process 1200 of FIG. 12, process 1300 of FIG. 13, or a combination thereof. In some aspects, the apparatus 900 or one or more components shown in FIG. 9 may include one or more components of the base station described above in connection with FIG. 2. Additionally, or alternatively, one or more components shown in FIG. 9 may be implemented within one or more components described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 906. In some aspects, the reception component 902 may include one or more antennas, a demodulator, a MIMO detector, a receive processor, a controller/processor, a memory, or a combination thereof, of the base station described above in connection with FIG. 2.

In some aspects, the reception component 902 may be a component of a processing system. For example, a processing system of the apparatus 900 may refer to a system including the various other components or subcomponents of the apparatus 900.

The transmission component 904 may transmit communications, such as reference signals, control information, data communications, or a combination thereof, to the apparatus 906. In some aspects, one or more other components of the apparatus 906 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modulator, a transmit MIMO processor, a transmit processor, a controller/processor, a memory, or a combination thereof, of the base station described above in connection with FIG. 2. In some aspects, the transmission component 904 may be collocated with the reception component 902 in a transceiver.

In some aspects, the transmission component 904 may be a component of a processing system. For example, a processing system of the apparatus 900 may refer to a system including the various other components or subcomponents of the apparatus 900.

The processing system of the apparatus 900 may interface with other components of the apparatus 900, and may process information received from other components (such as inputs or signals), output information to other components, etc. For example, a chip or modem of the apparatus 900 may include a processing system, the reception component 902 to receive or obtain information, and the transmission component 904 to output, transmit or provide information. In some cases, the reception component 902 may refer to an interface between the processing system of the chip or modem and a receiver, such that the apparatus 900 may receive information or signal inputs, and the information may be passed to the processing system. In some cases, the transmission component 904 may refer to an interface between the processing system of the chip or modem and a transmitter, such that the apparatus 900 may transmit information output from the chip or modem. A person having ordinary skill in the art will readily recognize that the second interface also may obtain or receive information or signal inputs, and the first interface also may output, transmit or provide information.

In some aspects, the transmission component 904 may transmit, to the apparatus 906, a TCI for a beam, where the TCI indicates one or more reference signals providing one or more properties of the beam. Accordingly, the transmission component 904 may transmit, to the apparatus 906, downlink data or control information using the beam. For example, the modulation component 908 may encode the downlink data or control information based on the one or more properties. In some aspects, the modulation component 908 may include one or more antennas, a modulator, a transmit MIMO processor, a transmit processor, a controller/processor, a memory, or a combination thereof, of the base station described above in connection with FIG. 2. Additionally, the reception component 902 may receive, from the apparatus 906, uplink data or control information using the beam. For example, the filtering component 910 may filter signals, from the apparatus 906, that encode the uplink data or control information, based on the one or more properties. In some aspects, the filtering component 910 may include one or more antennas, a demodulator, a MIMO detector, a receive processor, a controller/processor, a memory, or a combination thereof, of the base station described above in connection with FIG. 2.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

FIG. 10 is a diagram illustrating an example process 1000 performed, for example, by a UE. The process 1000 is an example where the UE (for example, the UE 120 of FIG. 1 or the apparatus 800 of FIG. 8) performs operations associated with joint downlink and uplink TCI for inter-cell mobility.

As shown in FIG. 10, in some aspects, the process 1000 may include receiving a communication from a non-serving neighbor cell (block 1010). For example, the UE (such as by using reception component 802, depicted in FIG. 8) may receive the communication from the non-serving neighbor cell, as described herein.

As further shown in FIG. 10, in some aspects, the process 1000 may include determining a parameter associated with a joint downlink and uplink TCI state based on the received communication from the non-serving neighbor cell (block 1020). For example, the UE (such as by using determination component 812, depicted in FIG. 8) may determine the parameter associated with the joint downlink and uplink TCI state based on the received communication from the non-serving neighbor cell, as described herein.

The process 1000 may include additional aspects, such as any single aspect or any combination of aspects described below or in connection with one or more other processes described elsewhere herein.

In a first additional aspect, the parameter is a QCL parameter or a spatial relationship parameter.

In a second additional aspect, alone or in combination with the first aspect, the parameter is a downlink QCL parameter.

In a third additional aspect, alone or in combination with one or more of the first and second aspects, the parameter is associated with uplink spatial relationship information.

In a fourth additional aspect, alone or in combination with one or more of the first through third aspects, the communication is a reference signal or a physical channel communication.

In a fifth additional aspect, alone or in combination with one or more of the first through fourth aspects, the process 1000 includes determining (for example, using determination component 812) a common beam for downlink reception and uplink transmission based on the joint downlink and uplink TCI state.

In a sixth additional aspect, alone or in combination with one or more of the first through fifth aspects, the common beam is dynamically configured using at least one of an RRC communication, a medium access control (MAC) control element (MAC-CE), or DCI.

In a seventh additional aspect, alone or in combination with one or more of the first through sixth aspects, the communication includes at least one of an SSB, a CSI-RS, a PRS, an SRS, a PDCCH, a PDSCH, a PUCCH, a PUSCH, or a PRACH.

In an eighth additional aspect, alone or in combination with one or more of the first through seventh aspects, the non-serving neighbor cell is associated with a cell identifier corresponding to a physical cell identifier or another type of cell identifier.

In a ninth additional aspect, alone or in combination with one or more of the first through eighth aspects, the cell identifier is configured for each possible communication in the joint downlink and uplink TCI state.

Although FIG. 10 shows example blocks of the process 1000, in some aspects, the process 1000 may include additional blocks, fewer blocks, different blocks, or differently arranged blocks than those depicted in FIG. 10. Additionally, or alternatively, two or more of the blocks of the process 1000 may be performed in parallel.

FIG. 11 is a diagram illustrating an example process 1100 performed, for example, by a UE. The process 1100 is an example where the UE (for example, the UE 120 of FIG. 1 or the apparatus 800 of FIG. 8) performs operations associated with joint downlink and uplink TCI for inter-cell mobility.

As shown in FIG. 11, in some aspects, the process 1100 may include receiving a communication from a non-serving neighbor cell (block 1110). For example, the UE (such as by using reception component 802, depicted in FIG. 8) may receive the communication from the non-serving neighbor cell, as described herein.

As further shown in FIG. 11, in some aspects, the process 1100 may include determining an uplink spatial relationship parameter associated with an uplink TCI state based on the received communication from the non-serving neighbor cell (block 1120). For example, the UE (such as by using determination component 812, depicted in FIG. 8) may determine the uplink spatial relationship parameter associated with the uplink TCI state based on the received communication from the non-serving neighbor cell, as described herein.

The process 1100 may include additional aspects, such as any single aspect or any combination of aspects described below or in connection with one or more other processes described elsewhere herein.

In a first additional aspect, the communication is a reference signal or a physical channel communication.

In a second additional aspect, alone or in combination with the first aspect, the process 1100 includes determining (for example, using determination component 812) an uplink beam for an uplink transmission based on the uplink TCI state.

In a third additional aspect, alone or in combination with one or more of the first and second aspects, the uplink beam is dynamically configured using at least one of an RRC communication, a MAC-CE, or DCI.

In a fourth additional aspect, alone or in combination with one or more of the first through third aspects, the communication includes at least one of the communication includes at least one of an SSB, a CSI-RS, a PRS, an SRS, a PDCCH, a PDSCH, a PUCCH, a PUSCH, or a PRACH.

In a fifth additional aspect, alone or in combination with one or more of the first through fourth aspects, the non-serving neighbor cell is associated with a cell identifier corresponding to a physical cell identifier or another type of cell identifier.

In a sixth additional aspect, alone or in combination with one or more of the first through fifth aspects, the cell identifier is configured for each possible communication in the uplink TCI state.

Although FIG. 11 shows example blocks of the process 1100, in some aspects, the process 1100 may include additional blocks, fewer blocks, different blocks, or differently arranged blocks than those depicted in FIG. 11. Additionally, or alternatively, two or more of the blocks of the process 1100 may be performed in parallel.

FIG. 12 is a diagram illustrating an example process 1200 performed, for example, by a BS. The process 1200 is an example where the BS (for example, the BS 110 of FIG. 1 or the apparatus 900 of FIG. 9) performs operations associated with joint downlink and uplink TCI for inter-cell mobility.

As shown in FIG. 12, in some aspects, the process 1200 may include determining a parameter associated with a joint downlink and uplink TCI state (block 1210). For example, the BS (such as by using determination component 912, depicted in FIG. 9) may determine a parameter associated with a joint downlink and uplink TCI state, as described herein.

As further shown in FIG. 12, in some aspects, the process 1200 may include transmitting a communication via a non-serving neighbor cell to indicate the parameter (block 1220). For example, the BS (such as by using transmission component 904, depicted in FIG. 9) may transmit a communication via a non-serving neighbor cell to indicate the parameter, as described herein.

The process 1200 may include additional aspects, such as any single aspect or any combination of aspects described below or in connection with one or more other processes described elsewhere herein.

In a first additional aspect, the parameter is a QCL parameter or a spatial relationship parameter.

In a second additional aspect, alone or in combination with the first aspect, the parameter is a downlink QCL parameter.

In a third additional aspect, alone or in combination with one or more of the first and second aspects, the parameter is associated with uplink spatial relationship information.

In a fourth additional aspect, alone or in combination with one or more of the first through third aspects, the communication is a reference signal or a physical channel communication.

In a fifth additional aspect, alone or in combination with one or more of the first through fourth aspects, the parameter indicates, in connection with the joint downlink and uplink TCI state, a common beam for downlink reception and uplink transmission.

In a sixth additional aspect, alone or in combination with one or more of the first through fifth aspects, the common beam is dynamically configured using at least one of a RRC communication, a MAC-CE, or DCI.

In a seventh additional aspect, alone or in combination with one or more of the first through sixth aspects, the communication includes at least one of an SSB, a CSI-RS, a PRS, a SRS, a PDCCH, a PDSCH, a PUCCH, a PUSCH, or a PRACH.

In an eighth additional aspect, alone or in combination with one or more of the first through seventh aspects, the non-serving neighbor cell is associated with a cell identifier corresponding to a physical cell identifier or another type of cell identifier.

In a ninth additional aspect, alone or in combination with one or more of the first through eighth aspects, the cell identifier is configured for each possible communication in the joint downlink and uplink TCI state.

Although FIG. 12 shows example blocks of the process 1200, in some aspects, the process 1200 may include additional blocks, fewer blocks, different blocks, or differently arranged blocks than those depicted in FIG. 12. Additionally, or alternatively, two or more of the blocks of the process 1200 may be performed in parallel.

FIG. 13 is a diagram illustrating an example process 1300 performed, for example, by a BS. The process 1300 is an example where the BS (for example, BS 110 of FIG. 1 or apparatus 900 of FIG. 9) performs operations associated with joint downlink and uplink TCI for inter-cell mobility.

As shown in FIG. 13, in some aspects, the process 1300 may include determining an uplink spatial relationship parameter associated with an uplink TCI state (block 1310). For example, the BS (such as by using determination component 912, depicted in FIG. 9) may determine an uplink spatial relationship parameter associated with an uplink TCI state, as described herein.

As further shown in FIG. 13, in some aspects, the process 1300 may include transmitting a communication via a non-serving neighbor cell to indicate the parameter (block 1320). For example, the BS (such as by using transmission component 904, depicted in FIG. 9) may transmit a communication via a non-serving neighbor cell to indicate the parameter, as described herein.

The process 1300 may include additional aspects, such as any single aspect or any combination of aspects described below or in connection with one or more other processes described elsewhere herein.

In a first additional aspect, the communication is a reference signal or a physical channel communication.

In a second additional aspect, alone or in combination with the first aspect, the parameter indicates an uplink beam for an uplink transmission based on the uplink TCI state.

In a third additional aspect, alone or in combination with one or more of the first and second aspects, the uplink beam is dynamically configured using at least one of a RRC communication, a MAC-CE, or DCI.

In a fourth additional aspect, alone or in combination with one or more of the first through third aspects, the communication includes at least one of a SSB, a CSI-RS, a PRS, an SRS, a PDCCH, a PDSCH, a PUCCH, a PUSCH, or a PRACH.

In a fifth additional aspect, alone or in combination with one or more of the first through fourth aspects, the non-serving neighbor cell is associated with a cell identifier corresponding to a physical cell identifier or another type of cell identifier.

In a sixth additional aspect, alone or in combination with one or more of the first through fifth aspects, the cell identifier is configured for each possible communication in the uplink TCI state.

Although FIG. 13 shows example blocks of the process 1300, in some aspects, the process 1300 may include additional blocks, fewer blocks, different blocks, or differently arranged blocks than those depicted in FIG. 13. Additionally, or alternatively, two or more of the blocks of the process 1300 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, satisfying a threshold may refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a-b, a-c, b-c, and a-b-c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms. Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A method of wireless communication performed by an apparatus of a user equipment (UE), comprising:
receiving, from a base station (BS), a transmission configuration indicator (TCI) for a beam, wherein the TCI indicates one or more reference signals providing one or more properties of the beam;
transmitting, to the BS, uplink data or control information using the beam; and
receiving, from the BS, downlink data or control information using the beam.

2. The method of claim 1, wherein the TCI includes an identifier.

3. The method of claim 2, wherein the identifier is in a field for common beam configurations, or the identifier is in a field shared between common beam configurations, downlink beam configurations, and uplink beam configurations.

4. The method of claim 1, wherein the one or more reference signals include at least one of:
a synchronization signal,
a channel state information reference signal (CSI-RS),
a sounding reference signal (SRS),
a positioning reference signal (PRS),
a physical random access channel (PRACH) signal,
a demodulation reference signal (DMRS),
or a combination thereof.

5. The method of claim 1, wherein the one or more properties for the beam include at least one of:
a Doppler shift,
a Doppler spread,
an average delay,
a delay spread,
a spatial reception filter,
spatial relation information for transmission,
or a combination thereof.

6. The method of claim 1, wherein the TCI further indicates one or more timing advance (TA) parameters to use when transmitting.

7. The method of claim 6, wherein the one or more TA parameters include at least one of:
a TA value,
an identifier of a TA group,
or a combination thereof.

8. The method of claim 6, wherein the TCI indicates a plurality of beams, each beam sharing the one or more TA parameters or using different TA parameters.

9. The method of claim 1, wherein the TCI further indicates one or more identifiers of one or more antenna panels associated with the apparatus of the UE.

10. The method of claim 9, wherein the one or more identifiers include at least one identifier associated with downlink communications and at least one identifier associated with uplink communications, or the one or more identifiers include at least one identifier associated with both downlink communications and uplink communications.

11. The method of claim 9, wherein the one or more identifiers include at least one of:
an identifier of an antenna port group, or
an identifier of a beam group.

12. The method of claim 9, wherein the one or more antenna panels include a plurality of antenna panels, each panel using a different analog beam, uplink power control parameter, uplink timing advance parameter, or a combination thereof.

13. The method of claim 9, wherein the TCI indicates a plurality of beams, each beam being associated with different identifiers of one or more antenna panels associated with the apparatus of the UE.

14. An apparatus of a user equipment (UE) for wireless communication, comprising:
a first interface configured to obtain a transmission configuration indicator (TCI) for a beam, wherein the TCI indicates one or more reference signals providing one or more properties of the beam;
a second interface configured to output uplink data or control information using the beam; and
the first interface further configured to obtain downlink data or control information using the beam.

15. The apparatus of claim 14, wherein at least one of the one or more reference signals provides at least two properties for the beam.

16. The apparatus of claim 14, wherein the TCI further indicates at least one serving cell identifier associated with at least one of the one or more reference signals, at least one bandwidth part (BWP) identifier associated with at least one of the one or more reference signals, or a combination thereof.

17. The apparatus of claim 14, wherein the TCI indicates a plurality of sets, each set having one or more reference signals, that correspond to a plurality of beams.

18. The apparatus of claim 14, wherein the TCI further indicates one or more power control parameters to use when transmitting.

19. The apparatus of claim 18, wherein the one or more power control parameters include at least one of:
a pathloss reference signal,
a nominal power parameter,
a pathloss scaling factor,
a close-loop index,
an identifier of a power control group,
or a combination thereof.

20. The apparatus of claim 18, wherein the TCI indicates a plurality of beams, each beam sharing the one or more power control parameters or using different power control parameters.

21. The apparatus of claim 14, wherein the TCI further indicates one or more codebook or non-codebook parameters to use when transmitting.

22. The apparatus of claim 21, wherein the one or more codebook or non-codebook parameters include at least one of:
an SRS resource indicator (SRI),
a precoding matrix indicator (PMI),
a rank indicator (RI),
or a combination thereof.

23. The apparatus of claim 21, wherein the TCI indicates a plurality of beams, each beam using different codebook or non-codebook parameters.

24. A method of wireless communication performed by an apparatus of a user equipment (UE), comprising:
receiving a communication from a non-serving neighbor cell; and
determining a parameter associated with a joint downlink and uplink transmission configuration indicator (TCI) state based on the received communication from the non-serving neighbor cell.

25. The method of claim 24, wherein the parameter is a quasi-co-location (QCL) parameter or a spatial relationship parameter.

26. The method of claim 25, wherein the parameter is a downlink QCL parameter or is associated with uplink spatial relationship information.

27. The method of claim 24, wherein the communication is a reference signal or a physical channel communication.

28. The method of claim 24, further comprising:
determining a common beam for downlink reception and uplink transmission based on the joint downlink and uplink TCI state.

29. The method of claim 28, wherein the common beam is dynamically configured using at least one of a radio resource control (RRC) communication, a medium access control (MAC) control element (MAC-CE), or downlink control information (DCI).

30. A method of wireless communication performed by an apparatus of a user equipment (UE), comprising:
receiving a communication from a non-serving neighbor cell; and
determining an uplink spatial relationship parameter associated with an uplink transmission configuration indicator (TCI) state based on the received communication from the non-serving neighbor cell.

31. The method of claim 30, wherein the communication is a reference signal or a physical channel communication.

32. The method of claim 30, further comprising:
determining an uplink beam for an uplink transmission based on the uplink TCI state.

33. The method of claim 32, wherein the uplink beam is dynamically configured using at least one of a radio resource control (RRC) communication, a medium access control (MAC) control element (MAC-CE), or downlink control information (DCI).

34. An apparatus of a user equipment (UE) for wireless communication, comprising:
an interface configured to obtain a communication from a non-serving neighbor cell; and
a processing system configured to determine a parameter associated with a joint downlink and uplink transmission configuration indicator (TCI) state based on the received communication from the non-serving neighbor cell.

35. The apparatus of claim 34, wherein the processing system is further configured to:
determine a common beam for downlink reception and uplink transmission based on the joint downlink and uplink TCI state.

36. The apparatus of claim 35, wherein the common beam is dynamically configured using at least one of a radio resource control (RRC) communication, a medium access control (MAC) control element (MAC-CE), or downlink control information (DCI).

37. The apparatus of claim 34, wherein the communication includes at least one of:
a synchronization signal block (SSB),
a channel state information (CSI) reference signal (CSI-RS),
a positioning reference signal (PRS),
a sounding reference signal (SRS),
a physical downlink control channel (PDCCH),
a physical downlink shared channel (PDSCH),
a physical uplink control channel (PUCCH),
a physical uplink shared channel (PUSCH), or
a physical random access channel (PRACH).

38. The apparatus of claim 34, wherein the non-serving neighbor cell is associated with a cell identifier corresponding to a physical cell identifier or another type of cell identifier.

39. The apparatus of claim 38, wherein the cell identifier is configured for each possible communication in the joint downlink and uplink TCI state.

40. An apparatus of a user equipment (UE) for wireless communication, comprising:
an interface configured to obtain a communication from a non-serving neighbor cell; and
a processing system configured to determine an uplink spatial relationship parameter associated with an uplink transmission configuration indicator (TCI) state based on the received communication from the non-serving neighbor cell.

41-45. (canceled)
